(19) United States
(12) Patent Application Publication
(10) Pub. No.: US 2026/0281421 A1
(43) Pub. Date: Sep. 17, 2026

(54) DECISION RULES OF CROSS-COMPONENT MODEL PROPAGATION BASED ON BLOCK VECTORS AND MOTION VECTORS

(71) Applicant: MEDIATEK INC., Hsinchu City (TW)

(72) Inventors: Hsin-Yi TSENG, Hsinchu City (TW); Man-Shu CHIANG, Hsinchu City (TW); Chia-Ming TSAI, Hsinchu City (TW); Cheng-Yen CHUANG, Hsinchu City (TW); Chih-Wei HSU, Hsinchu City (TW)

(21) Appl. No.: 19/472,690

(22) PCT Filed: Aug. 30, 2024
(86) PCT No.: PCT/CN2024/115723

§ 371 Date: Oct. 5, 2025

Related U.S. Application Data
(60) Provisional application No. 63/535,788, filed on Aug. 31, 2023.

(51) Int. Cl. H04N 19/52; H04N 19/105; H04N 19/109; H04N 19/11; H04N 19/139; H04N 19/172; H04N 19/176; H04N 19/182; H04N 19/186; H04N 19/463

(52) U.S. Cl. CPC H04N 19/52; H04N 19/105; H04N 19/109; H04N 19/11; H04N 19/139; H04N 19/172; H04N 19/176; H04N 19/182; H04N 19/186; H04N 19/463

(57) ABSTRACT

A method of performing cross-component prediction for coding pixel blocks is provided. A current block has a first-color block and a second-color block. A video coder generates a reconstruction for the first-color block. The video coder inherits a cross-component model from a reference block, where the cross-component model is propagated to the reference block based on cross-component prediction information of two or more further reference blocks of the reference block by e.g., selecting one reference block from the more than one further reference blocks to provide the cross-component model for the current block. The more than one further reference blocks may be located by motion vectors or block vectors of the reference block. The video coder applies the inherited cross-component model to the reconstruction of the first-color block to generate a cross-component prediction of the second-color block. The video coder uses the generated cross-component prediction to encode or decode the current block.

### CROSS REFERENCE TO RELATED PATENT APPLICATION(S)

The present disclosure is part of a non-provisional application that claims the priority benefit of U.S. Provisional Patent Application No. 63/535,788, filed on 31 Aug. 2023. Content of above-listed application is herein incorporated by reference.

### TECHNICAL FIELD

The present disclosure relates generally to video coding. In particular, the present disclosure relates to methods of coding pixel blocks by cross-component prediction, specifically by propagating cross-component models.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors (MVs) and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU. In order to improve the coding performance and/or to reduce complexity for a system performing cross-component prediction, methods and apparatus for coding pixel blocks by cross-component prediction are disclosed.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method of performing cross-component prediction for coding pixel blocks. A current block has a first-color block and a second-color block. A video coder generates a reconstruction for the first-color block. The video coder inherits a cross-component model from a reference block, where the cross-component model is propagated to the reference block based on cross-component models of two or more further reference blocks of the reference block. The video coder applies the inherited cross-component model to the reconstruction of the first-color block to generate a cross-component prediction of the second-color block. The video coder uses the generated cross-component prediction to encode or decode the current block.

The more than one further reference blocks may be located by more than one motion vectors or block vectors of the reference block (such as when the reference block is a bidirectional inter-predicted block.) In some embodiments, the reference block is not coded by cross-component prediction.

In some embodiments, the video coder propagates the cross-component model by selecting one block from the more than one further reference blocks of the reference block to provide the cross-component model for the reference block. The one further reference block may be selected according to a set of predefined rules. The video coder may select the one further reference block by identifying a block that is coded by cross-component prediction. The video coder may select the only further reference block of the two or more further reference blocks that has a cross-component model. The video coder may select the one further reference block by identifying a block that is coded by current picture referencing (e.g., IBC mode), or by identifying a block that is coded by intra prediction, or by identifying a block that is coded by inter prediction.

In some embodiments, the one further reference block is selected by identifying a block having a shortest spatial distance from the reference block among the one or more further reference blocks. The spatial distance may be vertical or horizontal distance, or Euclidean distance, or Manhattan distance, or Minkowski distance. In some embodiments, the one further reference block is selected by identifying a block among the one or more further reference blocks having a shortest temporal distance from the reference block. The temporal distance of a block may be determined based on the POC of the further reference picture containing the block and the POC of the reference picture.

The one further reference block may be selected by identifying a block among the one or more further reference blocks having a QP that is closest to the quantization parameter of the reference block, or by identifying a block having a largest QP among the one or more further reference blocks, or by identifying a block having a smallest QP among the one or more further reference blocks, or identifying a block that is indicated by a L0 (or L1) motion vector among the one or more further reference blocks.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 conceptually illustrates chroma and luma samples that are used for derivation of linear model parameters.

FIG. 2 shows an example of classifying the neighbouring samples into two groups.

FIG. 3 conceptually illustrates the spatial components of a convolutional filter.

FIG. 4 illustrates gradient filters enabled for Gradient Linear Model (GLM).

FIG. 5 illustrates reconstruction of component samples using cross-component residual model (CCRM).

FIG. 6 illustrates the positions of luma samples relative to the chroma sample being predicted by the CCRM filter.

FIG. 7 illustrates predefined search area for intra template matching.

FIG. 8 shows luma blocks used to derive direct block vector for corresponding chroma blocks.

FIG. 9 illustrates the pre-defined positions of spatial neighboring blocks, from which to inherit model parameters.

FIG. 10 conceptually illustrates inheriting temporal neighboring model parameters.

FIGS. 11A-B illustrate a current block and its non-adjacent spatial neighboring blocks, from which model parameters may be inherited.

FIG. 12 conceptually illustrates examples of CCM information propagation based on block vectors.

FIG. 13 illustrates a current block having two block vectors identifying two reference blocks and that both have CCM information.

FIG. 14 illustrates examples of CCM information propagation based on motion vectors.

FIG. 15 illustrates a current block having two motion vectors identifying two reference blocks and that both have CCM information.

FIG. 16 illustrates an example video encoder that may implement cross-component prediction.

FIG. 17 illustrates portions of the video encoder that implement propagation of CCM information from multiple reference blocks.

FIG. 18 conceptually illustrates a process for propagating CCM information from multiple reference blocks when encoding a block.

FIG. 19 illustrates an example video decoder that may implement cross-component prediction.

FIG. 20 illustrates portions of the video decoder that implement propagation of CCM information from multiple reference blocks.

FIG. 21 conceptually illustrates a process for propagating CCM information from multiple reference blocks when decoding a block.

FIG. 22 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Cross Component Prediction

a. Cross Component Linear Model (CCLM)

Cross Component Linear Model (CCLM) or Linear Model (LM) mode is a cross component prediction mode in which chroma components of a block is predicted from the collocated reconstructed luma samples by linear models. The parameters (e.g., scale and offset) of the linear model are derived from already reconstructed luma and chroma samples that are adjacent to the block. For example, in VVC, the CCLM mode makes use of inter-channel dependencies to predict the chroma samples from reconstructed luma samples. This prediction is carried out using a linear model in the form of:

$$P ( i , j ) = α \cdot {rec}_{L}^{′} ( i , j ) + β \qquad ( 1 )$$

P(i, j) in eq. (1) represents the predicted chroma samples in a CU (or the predicted chroma samples of the current CU) and

$$r e {c}_{L}^{′} ( i , j )$$

represents the down-sampled reconstructed luma samples of the same CU (or the corresponding reconstructed luma samples of the current CU).

The CCLM model parameters α (scaling parameter) and β (offset parameter) are derived based on at most four neighboring chroma samples and their corresponding down-sampled luma samples. In LM_A mode (also denoted as LM-T mode), only the above or top-neighboring template is used to calculate the linear model coefficients. In LM_L mode (also denoted as LM-L mode), only left template is used to calculate the linear model coefficients. In LM-LA mode (also denoted as LM-LT mode), both left and above templates are used to calculate the linear model coefficients. In this disclosure, the term {LM_LA, LM_A, LM_L} and {CCLM_LT, CCLM_T, CCLM_L} are used interchangeably. The term CCLM_LT, LM_LA and CCLM_LA are also used interchangeably.

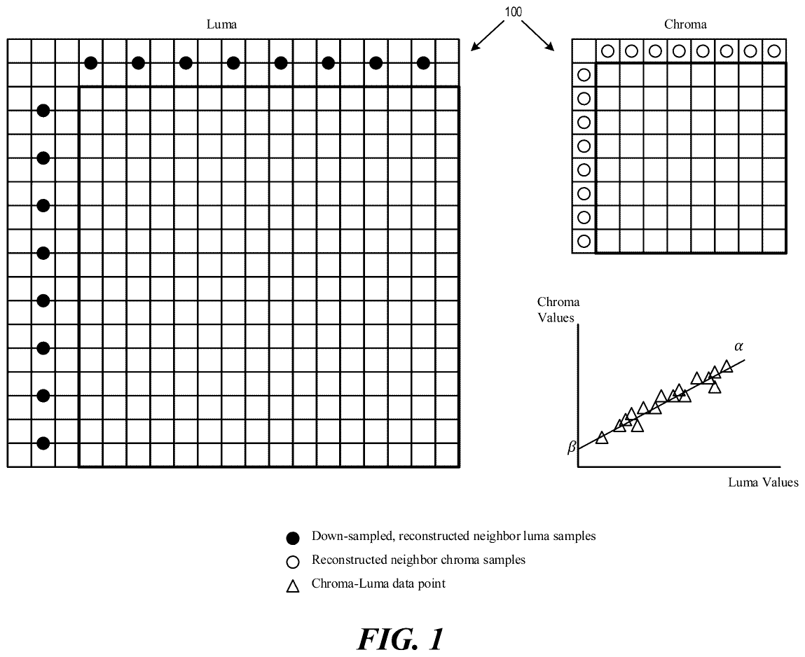

FIG. 1 conceptually illustrates chroma and luma samples that are used for derivation of linear model parameters. The figure illustrates a current block 100 having luma component samples and chroma component samples in 4:2:0 format. The luma and chroma samples neighboring the current block are reconstructed samples. These reconstructed samples are used to derive the cross-component linear model (parameters α and β). Since the current block in in 4:2:0 format, the luma samples are down-sampled first before being used for linear model derivation. In the example, there are 16 pairs of reconstructed luma (down-sampled) and chroma samples neighboring the current block. These 16 pairs of luma versus chroma values are used to derive the linear model parameters.

Suppose the current chroma block dimensions are W×H, then W′ and H′ are set as
W′=W, H′=H when LM-LT mode is applied;
W′=W+H when LM-T mode is applied;
H′=H+W when LM-L mode is applied

The above neighboring positions are denoted as S[0,−1] . . . S[W′−1,−1] and the left neighboring positions are denoted as S[−1, 0] . . . S[−1, H′−1]. Then the four samples are selected as
S[W′/4,−1], S[3*W′/4,−1], S[−1, H′/4], S[−1, 3*H′/4] when LM-LT mode is applied (both above and left neighboring samples are available);
S[W′/8,−1], S[3*W′/8,−1], S[5*W′/8,−1], S[7*W′/8,−1] when LM-T mode is applied (only the above neighboring samples are available);
S[−1, H′/8], S[−1, 3*H′/8], S[−1, 5*H′/8], S[−1, 7*H′/8] when LM-L mode is applied (only the left neighboring samples are available);

The four neighboring luma samples at the selected positions are down-sampled and compared four times to find two larger values: x⁰_{A}, and x¹_{A}, and two smaller values: x⁰_{B} and x¹_{B}. Their corresponding chroma sample values are denoted as y⁰_{A}, y¹_{A}, y⁰_{B} and y¹_{B}. Then X_{A}, X_{B}, Y_{A} and Y_{B} are derived as:

$${X}_{a} = ( {x}_{A}^{0} + {x}_{A}^{1} + 1 ) >> 1 ; {X}_{b} = ( {x}_{B}^{0} + {x}_{B}^{1} + 1 ) >> 1 ; \qquad ( 2 )$$

$${Y}_{a} = ( {y}_{A}^{0} + {y}_{A}^{1} + 1 ) >> 1 ; {Y}_{b} = ( {y}_{B}^{0} + {y}_{B}^{1} + 1 ) >> 1 \qquad ( 3 )$$

The linear model parameters α and β are obtained according to the following equations:

$$α = \frac{{Y}_{a} - {Y}_{b}}{{X}_{a} - {X}_{b}} \qquad ( 4 )$$

$$β = {Y}_{b} - α \cdot {X}_{b} \qquad ( 5 )$$

In some embodiments, to get more samples for calculating the CCLM model parameters α and β, the above template is extended to contain (W+H) samples for LM-T mode, the left template is extended to contain (H+W) samples for LM-L mode. For LM-LT mode, both the left template and the above templates are used to calculate the linear model coefficients.

To match the chroma sample locations for 4:2:0 video sequences, two types of down-sampling filters are applied to luma samples to achieve 2 to 1 down-sampling ratio in both horizontal and vertical directions. The selection of down-sampling filter is specified by a sequence parameter set (SPS) level flag. The two down-sampling filters are as follows, which correspond to “type-0” and “type-2” content, respectively.

$${rec}_{L}^{′} ( i , j ) = [ re {c}_{L} ( 2 i - 1 , 2 j - 1 ) + 2 * r e {c}_{L} ( 2 i , 2 j - 1 ) + r e {c}_{L} ( 2 i + 1 , 2 j - 1 ) + re {c}_{L} ( 2 i - 1 , 2 j ) + 2 * r e {c}_{L} ( 2 i , 2 j ) + r e {c}_{L} ( 2 i + 1 , 2 j ) + 4 ] >> 3 \qquad ( 6 )$$

$${rec}_{L}^{′} ( i , j ) = [ r e {c}_{L} ( 2 i , 2 j - 1 ) + r e {c}_{L} ( 2 i - 1 , 2 j ) + 4 * r e {c}_{L} ( 2 i , 2 j ) + r e {c}_{L} ( 2 i + 1 , 2 j ) + re {c}_{L} ( 2 i , 2 j + 1 ) + 4 ] >> 3 \qquad ( 7 )$$

b. Multi-Model CCLM (MMLM)

Multiple model CCLM mode (MMLM) uses two models for predicting the chroma samples from the luma samples for the whole CU. Similar to CCLM, three multiple model CCLM modes (MMLM_LA, MMLM_A, and MMLM_L) are used to indicate if both above and left neighboring samples, only above neighboring samples, or only left neighboring samples are used in model parameters derivation.

In MMLM, neighbouring luma samples and neighbouring chroma samples of the current block are classified into two groups, each group is used as a training set to derive a linear model (i.e., a particular a and B are derived for a particular group). Furthermore, the samples of the current luma block are also classified based on the same rule for the classification of neighbouring luma samples.

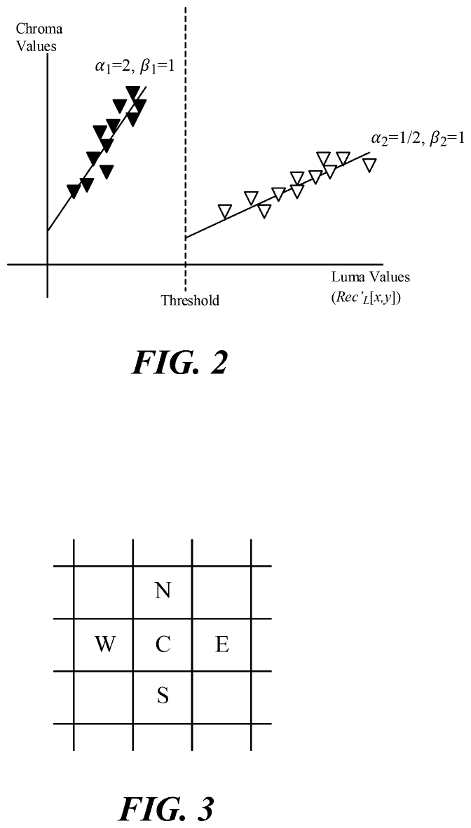

FIG. 2 shows an example of classifying the neighbouring samples into two groups.

Threshold is calculated as the average value of the neighbouring reconstructed luma samples. A neighbouring sample at [x,y] with Rec′_{L}[x,y]<=Threshold is classified into group 1; while a neighbouring sample at [x,y] with Rec′_{L}[x,y]>Threshold is classified into group 2. Thus, the multi-model CCLM prediction for the chroma samples is:

$$P r e {d}_{c} [ x , y ] = {α}_{1} \times {Rec}_{L}^{′} [ x , y ] + {β}_{1} if {Rec}_{L}^{′} [ x , y ] \leq Threshold$$

$$Pre {d}_{c} [ x , y ] = {α}_{2} \times {Rec}_{L}^{′} [ x , y ] + {β}_{2} if {Rec}_{L}^{′} [ x , y ] > Threshold$$

c. Convolutional Cross-Component Model (CCCM)

In some embodiments, a convolutional cross-component model (CCCM) is applied to improve the cross-component prediction performance. For some embodiment, the convolutional model has 7-tap filter having a 5-tap plus sign shape spatial component, a non-linear term and a bias term. The input to the spatial 5-tap component of the filter includes a center (C) luma sample (which is collocated with the chroma sample to be predicted) and the center luma sample's above/north (N), below/south(S), left/west (W) and right/east (E) neighbors. FIG. 3 conceptually illustrates the spatial components of a convolutional filter. The nonlinear term (denoted as P) is represented as power of two of the center luma sample C and scaled to the sample value range of the content:

$$P = ( C * C + midVal ) >> bitDepth \qquad ( 8 )$$

Thus, for 10-bit content the non-linear term P is calculated as:

$$P = ( C * C + 5 \; 12 ) >> 10$$

The bias term (denoted as B) represents a scalar offset between the input and output (similarly to the offset term in CCLM) and is set to middle chroma value (512 for 10-bit content). Output of the filter is calculated as a convolution between the filter coefficients ci and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B \qquad ( 9 )$$

d. Gradient Linear Model (GLM)

For YUV 4:2:0 color format, a gradient linear model (GLM) method can be used to predict the chroma samples from luma sample gradients. Two modes are supported: a two-parameter GLM mode and a three-parameter GLM mode.

Compared with the CCLM, instead of down-sampled luma values, the two-parameter GLM utilizes luma sample gradients to derive the linear model. Specifically, when the two-parameter GLM is applied, the input to the CCLM process, i.e., the down-sampled luma samples L, are replaced by luma sample gradients G.

$$C = α \cdot G + β$$

The other parts of the CCLM (e.g., parameter derivation, prediction sample linear transform) are kept unchanged. In the three-parameter GLM, a chroma sample can be predicted based on both the luma sample gradients and down-sampled luma values with different parameters:

$$C = {α}_{0} \cdot G + {α}_{1} \cdot L + {α}_{2} \cdot β$$

The model parameters of the three-parameter GLM are derived from 6 rows and columns adjacent samples by the LDL decomposition based MSE minimization method as used in the CCCM.

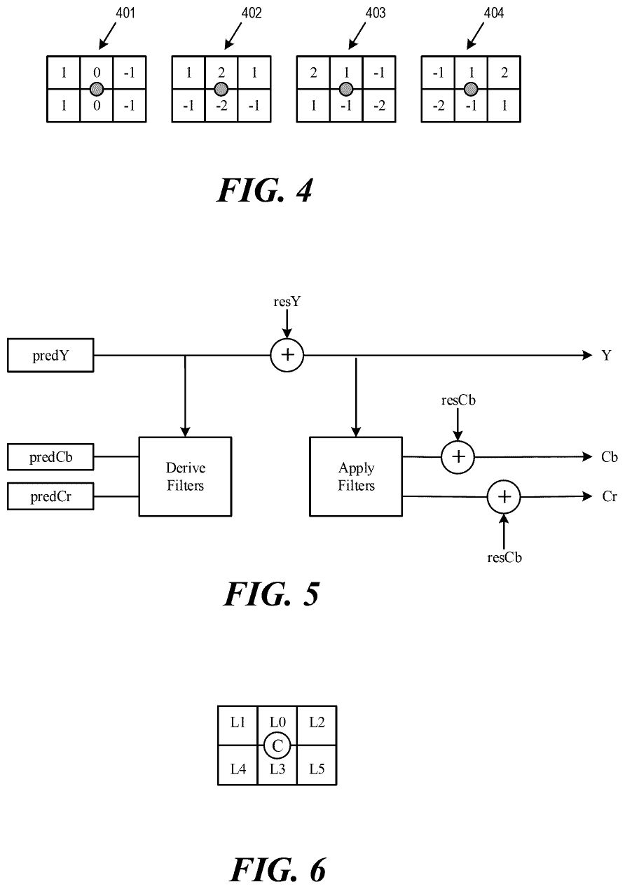

For signaling, when the CCLM mode is enabled to the current CU, one flag is signaled to indicate whether GLM is enabled for both Cb and Cr components; if the GLM is enabled, another flag is signaled to indicate which of the two GLM modes is selected and one syntax element is further signaled to select one of four gradient filters for the gradient calculation. FIG. 4 illustrates gradient filters enabled for Gradient Linear Model (GLM), specifically, the figure illustrates four Sobel based gradient patterns 401-404 for GLM. The gray dot in the middle of each gradient pattern represents the chroma position (C).

e. Cross-Component Residual Model (CCRM)

Cross-component residual model (CCRM) may be applied to predict chroma samples from reconstructed luma samples when the block uses inter prediction or intra block copy (IBC, which refers to coding pixel blocks by referencing pixel positions within same current picture as the current block by using block vectors.)

FIG. 5 illustrates reconstruction of component samples using cross-component residual model (CCRM). The figure illustrates the decoder side of the method. The cross-component filters are derived using the prediction signals of luma and chroma. The derived filters are applied to the reconstructed luma signal producing the final chroma predictions.

The derived filter may be an 8-tap filter consist of 6 spatial luma samples, a nonlinear term, and a bias term. FIG. 6 illustrates the positions of luma samples relative to the chroma sample being predicted by the CCRM filter. As illustrated, the spatial luma samples (L0, L1, L2, L3, L4, L5) are obtained from the luma grid by selecting the 6 luma samples closest to the chroma position C without down sampling. The filter predicted chroma value may be obtained as, predChromaVal=c₀L0+c₁L1+c₂L2+c₃L3+c₄L4+c₅L5+c₆ nonlinear ((L0+L3+1)>>1)+c₇ B, where “nonlinear” is CCCM's nonlinear operator and B is bias.

### II. Current Picture Referencing

a. Intra Block Copy (IBC)

Intra block copy (IBC) or current picture referencing (CPR) refer to coding pixel blocks by referencing pixel positions within same current picture as the current block by using block vectors.

b. Intra Template Matching

Intra template matching prediction (IntraTMP) is a special intra prediction mode that copies the best prediction block from the reconstructed part of the current frame, whose L-shaped template matches the current template. For a predefined search range, the encoder searches for the most similar template to the current template in a reconstructed part of the current frame and uses the corresponding block as a prediction block. The encoder then signals the usage of this mode, and the same prediction operation is performed at the decoder side. The prediction signal is generated by matching the L-shaped, Top-only or Left-Only causal neighbor of the current block with another block in a predefined search area.

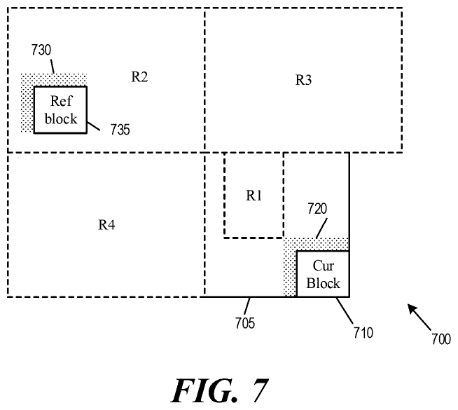

FIG. 7 illustrates predefined search area for intra template matching. As illustrated, for current block 710 having a current template area 720 in a current CTU 705, search is performed in several predefined search areas to search for a matching reference template area 730 (thereby finding the corresponding reference block 735.) The predefined search areas include R1 (in the current CTU), R2 (top-left of the current CTU), R3 (above the current CTU), and R4 (left of current CTU). The template matching is based on sum of absolute differences (SAD) as a cost function.

c. Direct Block Vector for Chroma Block

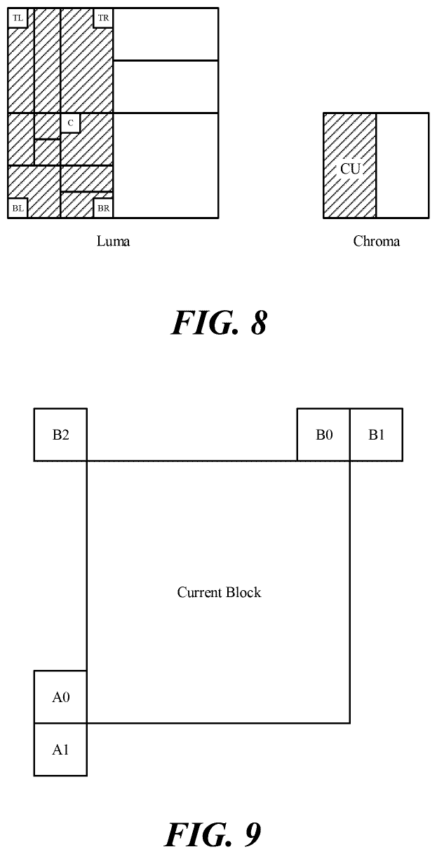

A direct block vector may be used for chroma blocks in dual tree slices. When a chroma dual tree is activated, a flag is signaled to indicate whether a chroma block is coded using IBC mode. Specifically, if one of the luma blocks in five predefined locations is coded with IBC or intraTMP mode, its block vector (BV) is scaled and is used as a block vector for the chroma block. Template matching is used to perform block vector scaling (from luma domain to chroma domain.) FIG. 8 shows luma blocks used to derive direct block vector for corresponding chroma blocks. The figure shows the five predefined locations that are used to determine whether a BV for a luma block is to be scaled and used as a BV for a chroma block.

### III. Inheriting Cross-Component Models

a. Inherit Neighboring Model Parameters

When applying cross-component prediction coding tool on the current block to generate prediction signals, the cross-component model (CCM) information, including model parameters can be inherited from neighboring blocks. In some embodiments, if the inherited neighbor block is coded in CCLM mode, the final scaling parameter of the current block is inherited from the neighboring blocks. Once the final scaling parameter is determined, the offset parameter (e.g., β in CCLM) is derived based on the inherited scaling parameter and the average value of neighboring luma and chroma samples of the current block.

In some embodiments, if the inherited neighbor block is coded in CCLM mode, after inheriting model parameters, the offset parameter can be inherited or can be further refined by dB For example, if the final offset parameter is inherited from a selected neighboring block, and the inherited offset parameter is β′ₙₑᵢ, then the final offset parameter is (β′ₙₑᵢ+dB). For example, dB can be signaled or derived based on the neighboring reconstructed samples. For example, dB can be zero.

In some embodiments, if the inherited neighbor block is coded with CCCM, the filter coefficients (cᵢ) are inherited. The offset parameter (e.g., c₆×B or c₆ in CCCM) can be re-derived based on the inherited parameter and the average value of neighboring corresponding position luma and chroma samples of the current block. In some embodiments, if the inherited neighbor block is coded using CCCM, the filter coefficients (cᵢ) are inherited. The offset parameter (e.g., c₆×B or c₆ in CCCM) is also inherited and is not re-derived when encoding or decoding the current block.

In some embodiments, if the inherited candidate applies GLM gradient pattern to its luma reconstruction samples, the current block may also inherit the GLM gradient pattern of the candidate and apply to the current luma reconstruction samples. In some embodiments, if the inherited neighbor block is coded using multiple cross-component models (e.g., MMLM, or CCCM with multi-model), the classification threshold is also inherited to classify the neighboring samples of the current block into multiple groups, and the inherited multiple cross-component model parameters are further assigned to each group.

b. Inheriting CCM Information

In some embodiments, the cross-component model (CCM) information of inherited cross-component model can be stored together with the inherited model parameters. The CCM information can be inherited together with the inherited model parameters. The prediction of the current block can be generated based on the inherited CCM information and/or the inherited model parameters.

The CCM information can include but not limited to: prediction mode (e.g., CCLM, MMLM, CCCM, CCCM with multi-models, 2-parameter GLM, 3-parameter GLM (GLM with luma terms), CCRM), information indicating whether non-linear terms are used in the model, model index for indicating which model shape is used in convolutional model, classification threshold for multi-model, information indicating whether non-downsampled samples are used in convolutional model, down-sampling filter flag, down-sampling filtering index when multiple down-sampling filters are used, information indicating whether multiple down-sampling filters are used, number of neighboring lines used to derive model, types of templates used to derive model (e.g., top-left, top, left), multi-model flag, post-filtering flag or model parameters.

In some embodiments, a mixed CCCM model that includes various terms (e.g., spatial term, gradient term, location term, non-linear term and bias term) can be inherited. In addition to storing model parameters, a prediction mode can be stored in the CCM information to indicate that the inherited model is a mixed CCCM model comprising various terms. For example, gradient and location based CCCM (GL-CCCM) is a mixed CCCM model which includes one spatial term in center position, two gradient terms for horizontal direction and vertical direction, two location terms X and Y for the relative horizontal location and relative vertical location, and one non-linear term and one bias term. A prediction mode can be stored in the CCM information to indicate that the inherited model is a GL-CCCM model. If there are multiple types of mixed CCCM models, a model index can also be stored in the CCM information to indicate which type of mixed CCCM model is inherited.

c. Inheriting Spatial Neighboring Model Parameters

In some embodiments, the inherited model parameters can be from a block that is an immediate neighboring block. The models from blocks at pre-defined positions are added into a CCP merge candidate list in a pre-defined order. The CCP merge candidate list may include models from spatial, temporal, and non-adjacent neighbors, and/or from history tables and/or from default models.

A video encoder may signal the index to select a CCP merge candidate from the list. The video decoder may generate the corresponding predictor of the current block based on the selected inherited candidate model parameters. In some embodiments, the video encoder may signal a flag to indicate whether CCP Merge mode is used (e.g., after cclm_mode_flag). In some embodiments, an on/off flag is signaled to indicate if the current block inherits the cross-component model parameters from neighboring blocks or not (i.e., CCP Merge mode is used or not). The flag can be signaled per CU/CB, per PU, per TU/TB, or per color component, or per chroma color component. In some embodiments, when the flag is true, an index is signaled to indicate which CCP Merge candidate is selected. If the current block inherits the cross-component model parameters from neighboring blocks, the inherit candidate index is signalled. The index can be signalled (e.g., signalled using truncate unary code, Exp-Golomb code, or fix length code) and shared among both the current Cb and Cr blocks.

In some embodiments, the pre-defined positions and the pre-defined order can be the same as those of spatial candidates for inter merge mode. FIG. 9 illustrates the pre-defined positions of spatial neighboring blocks, from which to inherit model parameters. The pre-defined order can be B₀, A₀, B₁, A₁ and B₂ as their respective model parameters are added to the CCP merge candidate list.

In some embodiments, assuming the position, width, and height of the current block are (x, y), W and H respectively, the pre-defined positions may include positions immediate above the current block, such as (x+W>>1, y−1) or (x+(W+1)>>1, y−1), if W is greater than or equal to a threshold TH. The pre-defined positions may also include positions immediate left to the current blocks, such as (x−1, y+H>>1) or (x−1, y+(H+1)>>1), if H is greater than or equal to a threshold TH. TH can be 2, 4, 8, 16, 32, or 64. The pre-defined positions include the positions at the immediate above (W>>1) or ((W>>1)−1) position if W is greater than or equal to TH, and the positions at the immediate left (H>>1) or ((H>>1)−1) position if H is greater than or equal to TH.

In some embodiments, there is a maximum number of inherited models from spatial neighbors that can be added into the CCP merge candidate list, and the maximum number is smaller than the number of pre-defined positions.

d. Inheriting Temporal Neighboring Model Parameters

In some embodiments, if the current slice/picture is a non-intra slice/picture, the inherited model parameters can be from the block in the previous coded slices/pictures.

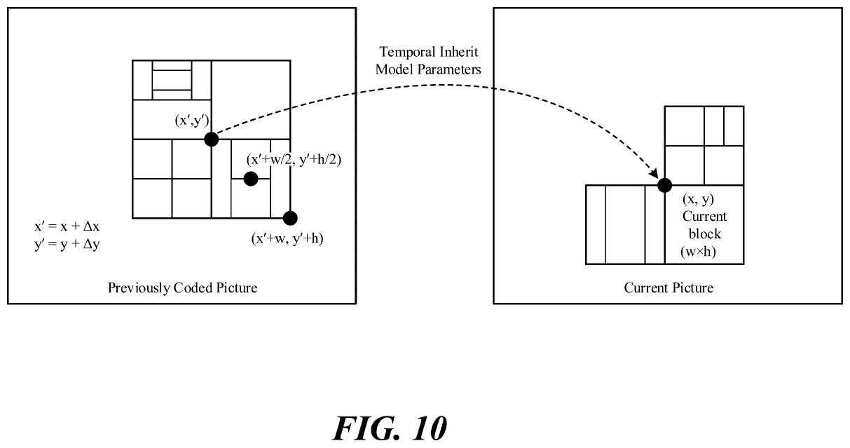

FIG. 10 conceptually illustrates inheriting temporal neighboring model parameters. As illustrated, the current position is at (x, y) and the block size is w×h. The inherited model parameters can be from the block at position (x′, y′), (x′, y′+h/2), (x′+w/2, y′), (x′+w/2, y′+h/2), (x′+w, y′), (x′, y′+h), or (x′+w, y′+h) of the previous coded slices/picture, where x′=x+Δx and y′=y+Δy. In some embodiments, if the prediction mode of the current block is intra, Δx and Δy are set to 0. If the prediction mode of the current block is inter, Δx and Δy are set to the horizontal and vertical motion vector of the current block. In some embodiments, if the current block is inter bi-prediction, Δx and Δy are set to the horizontal and vertical motion vector in reference picture list 0. In some embodiments, if the current block is inter bi-prediction, Δx and Δy are set to the horizontal and vertical motion vector in reference picture list 1.

In some embodiments, if the current slice/picture is a non-intra slice/picture, the inherited model parameters can be from the block in the previous coded slices/pictures. In one embodiment, the current block position is at (x, y) and the block size is w×h. The two value sets αₓ and α_{y} are defined

$${α}_{x} = \{ {α}_{x 1} , {α}_{x 2} , {α}_{x 3} , … , {α}_{x n} \} , {α}_{x i} < {α}_{x j} if i < j$$

$${α}_{y} = \{ {α}_{y 1} , {α}_{y 2} , {α}_{y 3} , … , {α}_{yn} \} , {α}_{yi} < {α}_{yj} if i < j$$

In some embodiments, all values in αₓ and α_{y} are positive numbers.

$$Let ( {x}_{m i d} , {y}_{m i d} ) = ( x + \frac{w}{2} , y + \frac{h}{2} ) .$$

The inherited model parameters can be from the block at positions (x_{mid}+αₓᵢ×w, y_{mid}±α_{yi}×h), (x_{mid}±αₓᵢ×w, y_{mid}), (x_{mid}, y_{mid}±α_{yi}×h) of the previous coded slices/picture.

In some embodiments, the current block position is at (x, y) and the block size is w×h. The inherited model parameters can be from the block at positions (x+αₓᵢ×w, y+α_{yi}×h), (x+αₓᵢ×w, y−α_{yi}×h), (x−αₓᵢ×w, y+α_{yi}×h), (x−αₓᵢ×w, y−α_{yi}×h), (x+αₓᵢ×w, y), (x−αₓᵢ×w, y), (x, y+α_{yi}×h), (x, y−α_{yi}×h) of the previous coded slices/picture.

In some embodiments, αₓ=α_{y}, e.g., αₓ=α_{y}={1, 2, 3, 4, 5}. In some embodiments,

$${α}_{x} \neq {α}_{y} , e . g . , {α}_{x} = \{ \frac{1}{2} , 1 , \frac{3}{2} , 2 , \frac{5}{2} \} and {α}_{y} = \{ 1 , 2 , 3 , 5 , 5 \} .$$

In some embodiments, the models from the positions closer to (x_{mid}, y_{mid}) are added into the final (CCP) merge candidate list first. In some embodiments, the models from the positions closer to (x, y) are added into the final (CCP) merge candidate list first.

In some embodiments, let δx and δy be two fixed positive numbers, the inherited model parameters can be from the block at positions (x_{mid}+αₓᵢ×δx, y_{mid}+α_{yi}×δy), (x_{mid}+αₓᵢ×δx, y_{mid}−α_{yi}×δy), (x_{mid}−αₓᵢ×δx, y_{mid}+α_{yi}×δy), (x_{mid}−αₓᵢ×δx, y_{mid}−α_{yi}×δy), (x_{mid}+αₓᵢ×δx, y_{mid}), (x_{mid}−αₓᵢ×δx, y_{mid}), (x_{mid}, y_{mid}+α_{yi}×δy), (x_{mid}, y_{mid}−α_{yi}×δy) of the previous coded slices/picture.

Let the current block position is at (x, y) and the block size is w×h. Let &x and Sy be two fixed positive numbers The inherited model parameters can be from the block at positions (x+αₓᵢ×δx, y+α_{yi}×δy), (x+αₓᵢ×δx, y−α_{yi}×δy), (x−αₓᵢ×δx, y+α_{yi}×δy), (x−αₓᵢ×δx, y−α_{yi}×δy), (x+αₓᵢ×δx, y), (x−αₓᵢ×δx, y), (x, y+α_{yi}×δy), (x, y−α_{yi}×δy) of the previous coded slices/picture.

In some embodiments, the current block position is at (x, y) and the block size is w×h. The inherited model parameters can be from the block at some pre-defined positions (x′, y′) of the previous coded slices/picture. For one example, the positions are inside the corresponding area of the current encoding block, i.e., x≤x′<x+w and y≤y′<y+h. The inherited model parameters can be from the block at.

$$( x , y ) , ( x + w - 1 , y ) , ( x , y + h - 1 ) , ( x + w - 1 , y + h - 1 ) , ( x + \frac{w}{2} , y + \frac{h}{2} ) .$$

For another example, the positions are outside of the corresponding area of the current encoding block, i.e., x′<x+ or x′>x+w, and y′<y or y′≥y+h. The inherited model parameters can be from the block at (x−1, y), (x, y−1), (x−1, y−1), (x+w, y), (x+w−1, y−1), (x+w, y−1), (x, y+h), (x−1, y+h−1), (x−1,y+h), (x+w, y+h−1), (x+w−1, y+h), (x+w, y+h).

In some embodiments, the inherited model parameters can be from the block at some pre-defined positions. The pre-defined positions and the inclusion order can be the same as those of inter merge mode. The previous coded picture which the inherited parameter model is from is referred as the collocated picture hereafter. In some embodiments, the previous coded picture the inherited parameter model is from, i.e., the collocated picture, is one of the pictures in the reference lists.

In some embodiments, the collocated picture can be the same as the collocated picture of inter merge mode. In some embodiments, the collocated picture is signaled in the picture/slice header. The reference list and the reference index are signaled in the picture/slice header. For example, the collocated picture is selected as L0[0]. For another example, the collocated picture is selected as L1 [0]. In some embodiments, the collocated picture is selected as the picture in the reference lists whose picture order count (POC) difference with the current picture is the smallest. (A picture order count of a picture is a value that indicates the temporal order of the picture in a sequence of pictures.) For example, if the POC of current picture is 8, the POCs of pictures in reference list 0 are {7, 6, 5, 0} and POCs of pictures in reference list 1 are {7, 6, 5, 4}, then L0[0] (equivalent to L1 [0]) is selected since its POC difference is the smallest. In some embodiment, if there are two pictures whose POC difference between it and the current picture are both the smallest, the picture with the smaller POC is selected. In some embodiment, if there are two pictures whose POC difference between it and the current picture are both the smallest, the picture with the larger POC is selected. In some embodiments, if there are two pictures whose POC difference between it and the current picture are both the smallest, the picture with smaller QP difference between it and the current picture is selected. In some embodiments, if there are two pictures whose POC difference between it and the current picture are both the smallest, the picture with the smaller QP is selected. In some embodiments, if there are two pictures whose POC difference between it and the current picture are both the smallest, the picture with the larger QP is selected.

In some embodiments, the collocated picture is selected as the picture in the reference lists whose QP difference between it and the current picture is the smallest. For example, if the QP of current picture is 28, and the QPs of the pictures in reference list 0 are {19, 26, 23} and the QPs of the pictures in reference list 1 are {23, 22, 21}. Then L0[1] is selected. In some embodiments, if there are more than one picture in the reference lists whose QP difference between it and the current picture are the smallest, the picture with the smaller QP is selected. In some embodiments, if there are more than one picture in the reference lists whose QP difference between it and the current picture are the smallest, the picture with the larger QP is selected. In some embodiments, if there are more than one picture whose QP difference between it and the current picture are the smallest, the picture with the smaller POC distance is selected. In some embodiments, the collocated picture is selected as the picture in the reference lists whose QP is the smallest. In some embodiments, the collocated picture is selected as the picture in the reference lists whose QP is the largest.

In some embodiments, the previous coded picture which the inherited parameter model is from, i.e., the collocated picture, is the most recently coded I-picture. The cross-component model information of the most recently coded I-slice/picture is stored in a long-term reference buffer.

In some embodiments, the collocated picture and the pre-defined positions where the inherited parameter model is from is determined by the motion vector of a neighboring block. For example, if the current block position is at (x, y) and the block size is w×h. The inherited model parameters can be from the block at position (x′, y′), (x′, y′+h/2), (x′+w/2, y′), (x′+w/2, y′+h/2), (x′+w, y′), (x′, y′+h), or (x′+w, y′+h) of the collocated picture, where x′=x+Δx and y′=y+Δy. In some embodiments, Δx and Δy are set to the L0 horizontal and vertical motion vector of the neighboring block, and the collocated picture is the L0 reference picture indicated by the L0 motion vector of the neighboring block. In some embodiments, if the neighboring block is inter bi-prediction, Δx and Δy are set to the L1 horizontal and vertical motion vector of the neighboring block, and the collocated picture is the L1 reference picture indicated by the L1 motion vector of the neighboring block. In some embodiments, the neighboring block is the left block of the current block. In some embodiments, the neighboring block is the above block of the current block.

In some embodiments, the pre-defined positions in the previous coded slices/pictures where the inherited parameter model is from is determined by the motion vector of a neighboring block. Let Δx and Δy be the horizontal and vertical displacement determined based on the selected motion vector of the neighboring block, the current block position is at (x, y) and the block size is w×h. The inherited model parameters can be from the block at position (x′, y′), where x′=x+Δx and y′=y+Δy, or where x′=x+w/2+Δx and y′=y+h/2+Δy.

In some embodiments, the inherited model parameters can also be from the positions in the patterns described in earlier paragraphs. The positions are centered at (x′, y′), where x′=x+Δx and y′=y+Δy, or where x′=x+w/2+Δx and y′=y+h/2+Δy. That is, denote the pre-defined positions as (x₁, y₁), (x₂, y₂), (x₃, y₃), . . . , (x_{N}, y_{N}), the inherited model parameters can be from (x₁+Δx, y₁+Δy), (x₂+Δx, y₂+Δy), (x₃+Δx, y₃+Δy), . . . , (x_{N}+Δx, y_{N}+Δy), where Δx and Δy are the horizontal and vertical displacements determined based on the selected motion vector of the neighbouring block. For example, let the current block size be w×h. The two value sets αₓ and α_{y} are defined as:

$${α}_{x} = \{ {α}_{x 1} , {α}_{x 2} , {α}_{x 3} , … , {α}_{x n} \} , {α}_{x i} < {α}_{x j} if i < j$$

$${α}_{y} = \{ {α}_{y 1} , {α}_{y 2} , {α}_{y 3} , … , {α}_{yn} \} , {α}_{yi} < {α}_{yj} if i < j$$

All values in αₓ and α_{y} are positive numbers. The inherited model parameters can be from the block at positions (x′+αₓᵢ×w, y′+α_{yi}×h), (x′+αₓᵢ×w, y′−α_{yi}×h), (x′−αₓᵢ×w, y′+α_{yi}×h), (x′−αₓᵢ×w, y′−α_{yi}×h), (x′+αₓᵢ×w, y′), (x′−αₓᵢ×w, y′), (x′, y′+α_{yi}×h), (x′, y′−α_{yi}×h) of the previous coded slices/picture. For another example, let δx and δy be two fixed positive numbers. The inherited model parameters can be from the block at positions (x′+αₓᵢ×δx, y′+α_{yi}×δy), (x′+αₓᵢ×δx, y′−α_{yi}×δy), (x′−αₓᵢ×δx, y′+α_{yi}×δy), (x′−αₓᵢ×δx, y′−α_{yi}×δy), (x′+αₓᵢ×δx, y′), (x′−αₓᵢ×δx, y′), (x′, y′+α_{yi}×δy), (x′, y′−α_{yi}×δy) of the previous coded slices/picture. For another example, the inherited model parameters can be from the block at some pre-defined positions relative to (x′, y′) of the previous coded slices/picture. The positions can be

$$( {x}^{′} , {y}^{′} ) , ( {x}^{′} + w - 1 , {y}^{′} ) , ( {x}^{′} , {y}^{′} + h - 1 ) ,$$

$$( {x}^{′} + w - 1 , {y}^{′} + h - 1 ) , ( {x}^{′} + \frac{w}{2} , {y}^{′} + \frac{h}{2} ) .$$

another example, the positions can be (x′−1, y′), (x′, y′−1), (x′−1, y′−1), (x′+W, y′), (x′+w−1, y′−1), (x′+w, y′−1), (x′, y′+h), (x′−1, y′+h−1), (x′−1, y′+h), (x′+w, y′+h−1), (x′+w−1, y′+h), (x′+w, y′+h).

In some embodiments, the neighboring block can be at a pre-defined position. For example, the position can be at the A₀ position as depicted in FIG. 9. The pre-defined position can also be at A₁, B₀, B₁, B₂. If the block at the pre-defined position is not an inter block, no neighboring block is selected.

In some embodiments, when selecting the neighboring block, there can be a list of pre-defined positions. The positions are placed according to the checking order. For example, the positions can be B₀, A₀, B₁, A₁ and B₂ as depicted in FIG. 9. The selected neighboring block can be the first position in the list that is an inter block. The L0 motion vector is selected. If the L0 motion vector is not available, select the L1 motion vector. For another example, the L1 motion vector is selected. If the L1 motion vector is not available, select the L0 motion vector.

In some embodiments, if the collocated picture has been determined (e.g., it can be determined with the methods described in earlier paragraphs in this section), the positions in the list of pre-defined positions are checked in the pre-defined checking order. The selected motion vector is the first whose reference picture is the collocated picture. For example, the positions can be B₀, A₀, B₁, A₁ and B₂ as depicted in FIG. 9. For each position, the L0 motion vector is first checked, and then the L1 motion vector. That is, the checking order is (B₀, L₀), (B₀, L1), (A₀, L₀), (A₀, L1), . . . , (B₂, L1). In some embodiments, the L1 motion vector is first checked, and then the L0 motion vector.

In some embodiments, the inherited model parameters can also be from the positions in the patterns described above. The positions are centered at (x′, y′), where x′=x+Δx and y′=y+Δy. The horizontal and vertical displacement Δx and Δy are determined based on the selected motion vector of the neighboring block. For example, if the reference picture of the selected motion vector and the collocated picture are the same picture, Δx equals to the horizontal part of the selected motion vector and Δy equals to the vertical part of the selected motion vector. If the horizontal part or the vertical part of the selected motion vector is fractional, Δx equals to the horizontal part of the selected motion vector after rounding and Δy equals to the vertical part of the selected motion vector after rounding. The rounding method used can be but not limited to the following methods: rounding toward negative infinity, rounding toward positive infinity, rounding toward zero, or rounding to the nearest integer (e.g., rounding away from zero, rounding half up, rounding half down, . . . ). For another example, if the reference picture of the selected motion vector and the collocated picture are not the same. The reference picture can be one of the pictures in the reference list, while the collocated picture is signaled in the picture/slice header. Let the POC distance between the current picture and the reference picture of the selected motion vector be tb, and the POC distance between the current picture and the collocated picture be td, the selected motion vector be (mv_x, mv_y). Δx=mv_x*(td/tb) and Δy=mv_y*(td/tb). If mv_x*(td/tb) or mv_y*(td/tb) is fractional, Δx equals to mv_x*(td/tb) after rounding or the horizontal part of the selected motion vector after rounding and Δy equals to mv_y*(td/tb) after rounding or the vertical part of the selected motion vector after rounding. The rounding method used can be but not limited to the following methods: rounding toward negative infinity, rounding toward positive infinity, rounding toward zero, or rounding to the nearest integer (e.g., rounding away from zero, rounding half up, rounding half down, . . . ).

In some embodiments, the inherited model parameters are derived by using the luma and chroma reconstruction samples of the collocated block. Let the current block position be at (x, y) and the block size is w×h. The collocated block is a block positioned at (x′, y′) in the collocated picture with block size w×h, when the inherited model is from position (x′, y′). For another example, the collocated block can be a block positioned at (x′, y′) in the collocated picture with block size m×n, where m and n are fixed positive values. For example, the collocated block can be at (x, y). For another example, if Δx and Δy are the L0 horizontal and vertical motion vector of the neighboring block, and the collocated picture is the L0 reference picture indicated by the L0 motion vector of the neighboring block, the collocated block can be at (x+Δx, y+Δy) in the collocated picture. (x′, y′) can be the positions in the patterns described in earlier paragraphs. For example, (x′, y′) can be (x+αₓᵢ×w, y+α_{yi}×h), (x+αₓᵢ×w, y−α_{yi}×h), (x−αₓᵢ×w, y+α_{yi}×h), (x−αₓᵢ×w, y−α_{yi}×h), (x+αₓᵢ×w, y), (x−αₓᵢ×w, y), (x, y+α_{yi}×h), (x, y−α_{yi}×h).

In some embodiments, the cross-component parameter model can be inherited from more than one previous coded picture. The cross-component parameter model can be inherited from any picture in a picture set, which contains N previous coded pictures. An index can be signaled/parsed in the bitstream to indicate the selected picture. The index ranges from 0 to N−1. In some embodiments, the picture whose POC difference between it and the current picture is smaller is associated with the smaller index. In another sub-embodiment, the picture whose QP difference between it and the current picture is smaller is associated with the smaller index. In some embodiments, the picture whose QP is smaller is associated with the smaller index. In some embodiments, the picture whose QP is larger is associated with the smaller index.

e. Inherit Non-Adjacent Spatial Neighboring Models

In some embodiments, the inherited model parameters can be from blocks that are non-adjacent spatial neighboring blocks (that are not adjacent to the current block). The models from blocks at pre-defined positions are added into the CCP merge candidate list in a pre-defined order. In some embodiments, the pre-defined positions and the pre-defined order are the same as those of non-adjacent spatial neighboring candidates for inter merge mode.

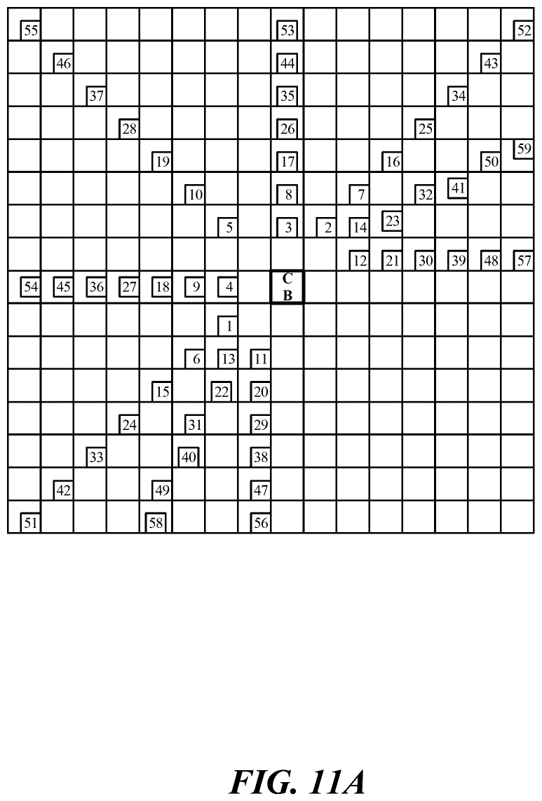

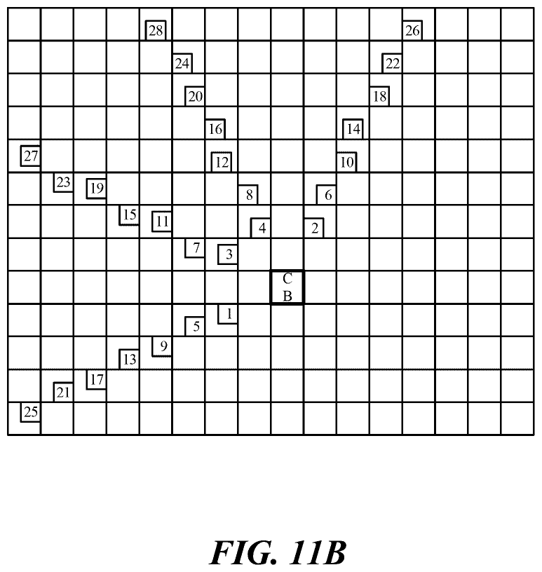

FIGS. 11A-B illustrate a current block 1100 and its non-adjacent spatial neighboring blocks, from which model parameters may be inherited. The figure also illustrates the pre-defined positions and their pre-defined order. FIG. 11A shows non-adjacent spatial positions in their pre-defined order according to a first pattern (Pattern 1). FIG. 11B shows non-adjacent spatial positions in their pre-defined order according to a second pattern (Pattern 2). The positions of the numbered squares are the pre-defined positions. The number inside each square indicates the pre-defined order. Positions in Pattern 1 is added into the CCP merge candidate list before positions in Pattern 2. The distance between each pre-defined positions are proportional to the width and height of the current block.

In some embodiments, there is a maximum number of inherited models from non-adjacent spatial neighbors that can be added into the CCP merge candidate list, and the maximum number is smaller than the number of pre-defined positions.

In some embodiments, let the current block position be (x, y) and the block size be w×h. The two value sets αₓ and α_{y} are defined as:

$${α}_{x} = \{ {α}_{x 1} , {α}_{x 2} , {α}_{x 3} , … , {α}_{xn} \} , {α}_{xi} < {α}_{xj} if i < j$$

$${α}_{y} = \{ {α}_{y 1} , {α}_{y 2} , {α}_{y 3} , … , {α}_{yn} \} , {α}_{yi} < {α}_{yj} if i < j$$

All values in αₓ and α_{y} are positive numbers. Let x′=x+Δx and y′=y+Δy. The inherited model parameters can be from the positions determined by x′ and y′. For example, the inherited model parameters can be from the block at positions (x′+αₓᵢ×w, y′+α_{yi}×h), (x′+αₓᵢ×w, y′−α_{yi}×h), (x′−αₓᵢ×w, y′+α_{yi}×h), (x′−αₓᵢ×w, y′−α_{yi}×h), (x′+αₓᵢ×w,0), (x′−αₓᵢ×w,0), (0, y′+α_{yi}×h), (0, y′−α_{yi}×h), (x′+αₓᵢ×w, y′), (x′−αₓᵢ×w, y′), (x′, y′+α_{yi}×h), (x′, y′−α_{yi}×h). For another example, let δx and δy be two fixed positive numbers. The inherited model parameters can be from the block at positions (x′+αₓᵢ×δx, y′+α_{yi}×δy), (x′+αₓᵢ×δx, y′−α_{yi}×y), (x′−αₓᵢ×δx, y′+α_{yi}×δy), (x′−αₓᵢ×δx, y′−α_{yi}×δy), (x′+αₓᵢ×δx, 0), (x′−αₓᵢ×δx, 0), (0, y′+α_{yi}×δy), (0, y′−α_{yi}×y), (x′+αₓᵢ×δx, y′), (x′−αₓᵢ×δx, y′), (x′, y′+α_{yi}×δy), (x′, y′−α_{yi}×δy). For another example, the inherited model parameters can be from the block at some pre-defined positions relative to (x′, y′) of the previous coded slices/picture. The positions can be

$$( {x}^{′} , {y}^{′} ) , ( {x}^{′} + w - 1 , {y}^{′} ) , ( {x}^{′} , {y}^{′} + h - 1 ) ,$$

$$( {x}^{′} + w - 1 , {y}^{′} + h - 1 ) , ( {x}^{′} + \frac{w}{2} , {y}^{′} + \frac{h}{2} ) .$$

For another example, the positions can be (x′−1, y′), (x′, y′−1), (x′−1, y′−1), (x′+w, y′), (x′+w−1, y′−1), (x′+w, y′−1), (x′, y′+h), (x′−1, y′+h−1), (x′−1, y′+h), (x′+w, y′+h−1), (x′+w−1, y′+h), (x′+w, y′+h). For another example, the position can be (x′, y′), (x′, y′+h/2), (x′+w/2, y′), (x′+w/2, y′+h/2), (x′+w, y′), (x′, y′+h), or (x′+w, y′+h).

In some embodiments, if the prediction mode of the current block is based on a block vector that references the current picture (e.g., intra-block copy mode (IBC) or IntraTMP), Δx and Δy can be set according to the horizontal and vertical block vector of the current block. For example, Δx and Δy can be equal to the horizontal and vertical block vector of the current block. In some embodiments, Δx and Δy can be set according to the horizontal and vertical block vector of a neighboring block. For example, Δx and Δy can be equal to the horizontal and vertical block vector of a neighboring block.

f. Inheriting Model Parameters from History Table

In some embodiments, the inherited model parameters can be from a cross-component model history table. The history table stores CCM information of valid previous coded blocks. The valid previous coded block refers to any blocks containing valid CCM information. The cross-component models in the history table can be added into the CCP merge candidate list according to a pre-defined order. In some embodiments, the adding order of historical candidate can be from the beginning of the table to the end of the table. In some embodiments, the adding order of historical candidate can be from the end of the table to the beginning of the table.

In some embodiments, one cross-component model history table can be maintained for storing the previous cross-component model (i.e., CCM information), and the cross-component model history table can be reset at the start of the current picture, current slice, current tile, every M CTU rows or every N CTUs, where N and M can be any value greater than 0. In some embodiments, the cross-component model history table can be reset at the end of the current picture, current slice, current tile, current CTU row or current CTU.

In some embodiments, multiple history tables are used for storing different types of cross-component models. For example, the first history table is used for storing single model, and the second history table is used for storing multi-model. For another example, the first history table is used for storing gradient model, and the second history table is used for storing non-gradient model. For another example, the first history table is used for storing simple linear model (e.g., y=ax+b), and the second history table is used for storing complicated model (e.g., CCCM).

In some embodiments, when adding historical candidates from multiple history tables to the CCP merge candidate list, the adding order can be from the beginning of to the end of a certain table, and then the next history table is added in the same order or in a reversed order.

g. Inheriting from Fusion Mode

Fusion mode refers to a mode that fuses two predictions to generate the final prediction. In the chroma intra fusion mode, a chroma intra prediction that is not generated using a cross-component prediction (CCP) coding tool (e.g., CCLM, MMLM, CCCM) is fused with another chroma intra prediction generated using a cross-component prediction coding tool. For example, a non-CCLM coded intra prediction and a CCLM coded intra prediction are fused together to obtain the final intra prediction.

In some embodiments, when inheriting the cross-component model parameters from the block/position coded by chroma intra fusion mode, the model parameters for obtaining the CCP coded intra prediction are inherited and further refined. In some embodiments, in addition to inheriting and refining the CCP model parameters, the fusion weight, the coding mode of non-CCP coded intra prediction are also inherited. That is, the chroma intra fusion mode is inherited.

h. Constructing Candidate List

In some embodiments, the CCP merge candidate list is constructed by adding candidates in a pre-defined order until the maximum candidate number is reached. The candidates added can include all or some of the forementioned candidates, but not limited to the forementioned candidates. For example, the pre-defined order can be spatial adjacent candidates, temporal candidates, spatial non-adjacent candidates, historical candidates, and then default candidates.

In some embodiments, if all the pre-defined neighboring and historical candidates are added but the maximum candidate number is not reached, some default candidates are added into the CCP merge candidate list until the maximum candidate number is reached. In some embodiments, the default candidates can be CCLM models. The scaling parameter a is from the set {0, 1/8, −1/8, 2/8, −2/8, . . . , N/8, −N/8}, where N is a positive integer.

The offset parameter β can be

$$\frac{1}{1 ≪ bit\_depth}$$

or can be derived based on neighboring luma and chroma samples. For example, if the average value of neighboring luma and chroma samples are lumaAvg and chromaAvg, β=chromaAvg−a·lumaAvg.

In some embodiments, the inclusion order of the default candidates can depend on the absolute value and the sign of the scaling parameter α. For example, the default candidates are added into the CCP merge candidate list according to α in the following order: 0, 1/8, −1/8, 2/8, −2/8, . . . , N/8, −N/8.

In some embodiments, a default candidate can be an earlier candidate with a delta scaling parameter refinement. The earlier candidate is a CCLM model. If the scaling parameter of an earlier candidate is α, the scaling parameter of a default candidate is (α+Δα). For example, Δα can be 1/8, −1/8, 2/8, −2/8, . . . N/8, −N/8, where N is a positive integer. The offset parameter β can be derived based on (α+Δα) and the average values of neighboring luma and chroma samples of the current block. In some embodiments, the earlier candidate is the first CCLM candidate added into the CCP merge candidate list. In some embodiments, the inclusion order of the default candidates can depend on the absolute value and the sign of the refinement Δα. For example, the default candidates for Aa are added into the CCP merge candidate list in the following order: 0, 1/8,−1/8, 2/8,−2/8, . . . , N/8,−N/8.

i. Reorder the Candidates in the List

The candidates in the CCP merge candidate list can be reordered to reduce the syntax overhead when signaling the selected candidate index. In some embodiments, the reordering rules may depend on the coding information of neighboring blocks. For example, if neighboring above or left blocks are coded by MMLM, the MMLM candidates in the list can be moved to the head of the current list. Similarly, if neighboring above or left blocks are coded by single model LM (i.e., CCLM) or CCCM, the single model LM or CCCM candidates in the list can be moved to the head of the current list. Similarly, if GLM is used by neighboring above or left blocks, the GLM related candidates in the list can be moved to the head of the current list.

In some embodiments, the reordering rule is based on the model error (i.e., template cost) by applying the candidate model to the neighboring templates of the current block, and then compare the error with the reconstruction samples of the neighboring template (i.e., the difference from the reconstruction samples of the neighboring template).

For example, say the size of above neighboring template of the current block is wₐ×hₐ, and the size of left neighboring template of the current block is w_{b}×h_{b}. Suppose K models (the models can be CCLM or 2-parameter GLM) are in the current candidate list, and αₖ and βₖ are the final scaling and offset parameters after inheriting the candidate k. The model error of candidate k by the above neighboring template is:

$${e}_{a}^{k} = {\sum }_{i , j} \vert ( {α}_{k} \times r e c {L}_{a}^{′ ( i , j )} + {β}_{k} ) - r e c {C}_{a}^{( i , j )} \vert$$

where,

$$r e c {L}_{a}^{′ ( i , j )} and {recC}_{a}^{( i , j )}$$

are the reconstruction samples of luma (e.g., after downsampling process or after applying GLM pattern) and reconstruction samples of chroma at position (i, j) in the above template, and 0≤i<wₐ and 0≤j<hₐ. Similarly, the model error of candidate k by the left neighboring template is:

$${e}_{b}^{k} = {\sum }_{m , n} \vert ( {α}_{k} \times r e c {L}_{b}^{′ ( m , n )} + {β}_{k} ) - r e c {C}_{b}^{( m , n )} \vert$$

where

$$r e c {L}_{b}^{′ ( m , n )} and {recC}_{b}^{( m , n )}$$

are the reconstruction samples of luma (e.g., after applying downsampling process or GLM pattern) and reconstruction samples of chroma at position (m, n) in the left template, and 0≤m<w_{b} and 0≤n<h_{b}. Then the model error of candidate k is:

$${e}^{k} = {e}_{a}^{k} + {e}_{b}^{k}$$

After calculating the model error among all candidates, it may obtain a model error list E={e⁰, e¹, e², . . . , e^{k}, . . . , e^{K}}. Then, the video coder can reorder the candidate index in the inherit candidate list (i.e., CCP merge candidate list) by sorting the model error list in ascending order. For example, the model error may also be the SATD between the predicted chroma samples on the templates generated by applying the candidate model to the luma samples on neighboring templates, and the reconstruction chroma samples of the neighboring template.

In some embodiment, if the candidate k uses CCCM prediction, the

$${e}_{a}^{k} and {e}_{b}^{k}$$

may be defined as:

$${e}_{a}^{k} = {\sum }_{i , j} \vert ( c {0}_{k} \times r e c {L}_{a}^{′ ( i , j )} + c {1}_{k} \times r e c {L}_{a}^{′ ( i , j - 1 )} + c {2}_{k} \times r e c {L}_{a}^{′ ( i , j + 1 )} + c {3}_{k} \times r e c {L}_{a}^{′ ( i - 1 , j )} + c {4}_{k} \times r e c {L}_{a}^{′ ( i + 1 , j )} + c {5}_{k} \times P + c {6}_{k} \times B ) - r e c {C}_{a}^{( i , j )} \vert$$

$${e}_{b}^{k} = {\sum }_{m , n} \vert ( c {0}_{k} \times r e c {L}_{b}^{′ ( m , n )} + c {1}_{k} \times r e c {L}_{b}^{′ ( m , n - 1 )} + c {2}_{k} \times r e c {L}_{b}^{′ ( m , n + 1 )} + c {3}_{k} \times r e c {L}_{b}^{′ ( m - 1 , n )} + {c4}_{k} \times r e c {L}_{b}^{′ ( m + 1 , n )} + c {5}_{k} \times P + c {6}_{k} \times B ) - r e c {C}_{b}^{( m , n )} \vert$$

where c0ₖ, c1ₖ, c2ₖ, c3ₖ, c4ₖ, c5ₖ, and c6ₖ are the final filtering coefficients after inheriting the candidate k. P and B are the nonlinear term and bias term. In some embodiments, if the above neighboring template is not available, then

$${e}^{k} = {e}_{b}^{k} .$$

Similarly, if the left neighboring template is not available, then

$${e}^{k} = {e}_{a}^{k} .$$

If both templates are not available, the candidate index reordering method using model error is not applied.
j. Signaling Inherit Candidate Index

In some embodiments, an on/off flag is signaled to indicate if the current block inherits the cross-component model parameters from neighboring blocks or not. The flag can be signaled per CU/CB, per PU, per TU/TB, or per color component, or per chroma color component. A high-level syntax can be signaled in SPS, PPS, PH or SH to indicate if inheriting the cross-component model parameters from neighboring blocks is allowed for the current sequence, picture, or slice.

In some embodiments, the maximum allowed candidate number is signaled to indicate the maximum size of the merge candidate list. The number can be signaled per CU/CB, per PU, per TU/TB, or per color component, or per chroma color component. A high-level syntax can be signaled in SPS, PPS, PH or SH to indicate if the maximum allowed candidate number is allowed for the current sequence, picture, or slice. The maximum allowed candidate number can be shared with the maximum allowed candidate number for inter merge mode.

In some embodiments, if the current block inherits the cross-component model parameters from neighboring blocks, the inherit candidate index is signaled. The index can be signaled (e.g., signaled using truncate unary code, Exp-Golomb code, or fix length code) and shared among both the current Cb and Cr blocks. For example, the index can be signaled per color component. For another example, one inherited index is signaled for Cb component, and another inherited index is signaled for Cr component. For another example, the video coder can use chroma intra prediction syntax (e.g., IntraPredModeC[xCb][yCb]) to store the inherited index.

In some embodiments, if the current block inherits the cross-component model parameters from neighboring blocks, the current chroma intra prediction mode (e.g., IntraPredModeC[xCb][yCb] as defined in VVC standard) is temporally set to a cross-component mode (e.g., CCLM_LA) at the bitstream syntax parsing stage. Later, at the prediction stage or reconstruction stage, the candidate list is derived, and the inherited candidate model is then determined by the inherit candidate index. After obtaining the inherited model, the coding information of the current block is then updated according to the inherit candidate model. The coding information of the current block includes but not limited to the prediction mode (e.g., CCLM_LA or MMLM_LA), related sub-mode flags (e.g., CCCM mode flag), prediction pattern (e.g., GLM pattern index), and the current model parameters. Then, the prediction of the current block is generated according to the updated coding information.

k. Vector Propagated Cross-Component Models

In some embodiments, after encoding/decoding a block, the cross-component model (CCM) information of the current block is derived and stored for the current block. The stored CCM information can be referenced by the following coding blocks. The following coding blocks can inherit CCM information from the current block. The definition of CCM information is described in Section III.b “Inheriting CCM information”. The stored CCM information can be inherited as but not limited to the following types of candidates: spatial candidates, non-adjacent candidates, temporal candidates, historical candidates, as described in above sections.

In some embodiments, if the current block is cross-component prediction (CCP) coded, the cross-component model used by the current block can be stored and be referenced by the following coding blocks. When a block is CCP coded, that means the block uses a cross-component model to generate the prediction of the block. The block may use a cross-component model inherited from neighboring block, a cross-component model derived based on neighboring luma and chroma predicted/reconstructed sample values (e.g., CCLM, MMLM, CCCM, CCRM), cross-component model used in chroma fusion which means the chroma prediction is based on adding one or more hypotheses of cross-component prediction to one or more existing hypotheses of prediction of non-cross-component prediction, or any combination of the above.

In some embodiments, if the current block is not CCP coded, and this block is in a non-intra slice/picture, the CCM information of the current block can be derived by copying the CCM information of the collocated block. Assume the current block is at (x, y) and the block size is w*h, the collocated block can be the block at (x, y), (x+w, y+h), (x+w−1, y+h−1), or (x+w/2, y+h/2) in the collocated picture.

In some embodiments, if the current block is not CCP coded, and there are block vectors available in the current block, (e.g., the current luma block is coded in IBC or IntraTMP mode, the collocated luma block is coded in IBC or IntraTMP mode), the CCM information of the current block can be derived by copying the CCM information of the reference block located by the block vector.

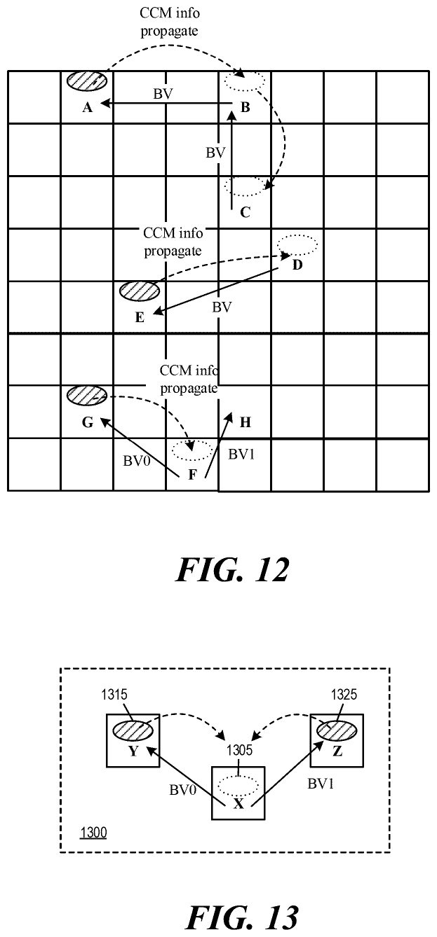

FIG. 12 conceptually illustrates examples of CCM information propagation based on block vectors. The figure illustrates several blocks A through H. The blocks A, E, G are coded by using cross-component model (e.g., CCLM, MMLM, GLM, CCCM, Chroma Fusion). Block B is not CCP coded and there are block vectors available at block B. The reference block A is located by the block vector. The CCM information of the reference block A, which uses cross-component model, is copied and stored for block B. In some embodiments, if the reference block located by the block vector is also not CCP coded, but there is CCM information stored for the reference block, the CCM information of the current block can be derived by copying the CCM information stored for the reference block. For example, as shown in FIG. 12, the current block C has block vector available, and its reference block B, which is not CCP coded, has CCM information stored. The CCM information of block B is copied and stored for block C. The CCM information stored for block B was copied from block A. Hence the CCM information of block A is propagated to block C. In some embodiments, if the reference block located by the block vector is not CCP coded and does not have CCM information stored, no CCM information is stored for the current block.

In some embodiments, when the current block has multiple block vectors available (e.g., the block vector can be bi-directional, the block can have multiple IntraTMP block vectors, or the current chroma block is collocated with multiple luma blocks and more than one of the luma blocks have block vectors), to derive the CCM information of the current block, if only one of the reference blocks located by the block vectors has CCM information, the CCM information from the reference block which has CCM information is copied to and stored for the current block. For example, as shown in FIG. 12, suppose block F has two block vectors and has two reference blocks G and H. Block G has CCM information and block H does not. The CCM information of block G is copied to and stored for block F.

In some embodiments, when the current block has multiple block vectors, and more than one of the reference blocks located by the block vectors has CCM information, the video coder determines/derives the CCM information to be stored for the current block based on the CCM information of the more than one reference blocks. FIG. 13 illustrates a current block having two block vectors identifying two reference blocks and that both have CCM information. As illustrated, a current block (block X) has two reference blocks (block Y and block Z) in a same current picture 1300. The reference block Y is identified by block vector BV0 and has CCM information 1315. The reference block Z is identified by block vector BV1 and has CCM information 1325. Block Y and Block Z may or may not be coded by CCP. The video coder determines the CCM information 1305 for the current block X based on the CCM information 1315 and the CCM information 1325.

The video coder in different embodiments determines the current block CCM information 1305 differently. For example, in some embodiments, the current block CCM information 1305 is derived by combining all or a subset of the CCM models of its reference blocks (e.g., CCM models 1315 and 1325 of reference blocks 1310 and 1320).

In some embodiments, when the current block (e.g., current block X of FIG. 13) has multiple block vectors, and more than one of the reference blocks (e.g., reference blocks Y and Z of FIG. 13) located by the block vectors has CCM information, one of the reference blocks is selected based on a set of pre-defined rules. The CCM information of the selected reference block is then copied and stored for the current block. In some embodiments, the reference block which is CCP coded is selected. In some embodiments, the reference block which is intra coded is selected. In some embodiments, the reference block which is inter or IBC coded is selected.

In some embodiments, the reference block whose distance to the current block is the smallest is selected. The CCM information of the selected reference block is copied to and stored for the current block. The distance between the reference block and the current block, located at (xᵣ, yᵣ) and (x_{c}, y_{c}) respectively, can be computed by Euclidean distance d=\sqrt{(xᵣ−x_{c})²+(yᵣ−y_{c})²}. (xᵣ, yᵣ) and (x_{c}, y_{c}) can be the top-left, top-right, bottom-left, bottom-right, or center positions of the reference block and the current block. The distance metric can also be Manhattan distance or Minkowski distance.

For some embodiments, the reference block which has the smallest horizontal distance, |xᵣ−x_{c}|, is selected. The CCM information of the selected reference block is copied to and stored for the current block. For some embodiments, the reference block which has the smallest vertical distance, |yᵣ−y_{c}|, is selected. The CCM information of the selected reference block is copied to and stored in in the current block.

For some embodiments, the rules described previously can be combined, and not all the rules described previously need to be applied. For example, the reference block which is CCP coded is selected. If there are more than one CCP coded reference blocks, then the block which has the shortest distance to the current block among the CCP coded reference blocks is selected. If there are more than one CCP coded reference blocks whose distances to the current block are the smallest, the reference block which has the smallest horizontal distance, |xᵣ−x_{c}|, is selected. For another example, the reference block which is CCP coded is selected. If there are more than one CCP coded reference blocks, then the block which has the shortest distance to the current block among the CCP coded reference blocks are selected. If there are more than one CCP coded reference blocks whose distances to the current block are the smallest, the reference block which has smallest vertical distance, |yᵣ−y_{c}|, is selected. The CCM information of the selected reference block is copied to and stored for the current block.

In some embodiments, if the current block is not CCP coded and there are motion vectors available in the current block (e.g. the current luma block is inter-coded), the CCM information of the current block can be derived by copying the CCM information of its reference block in a reference picture, located by the motion vectors of the current block.

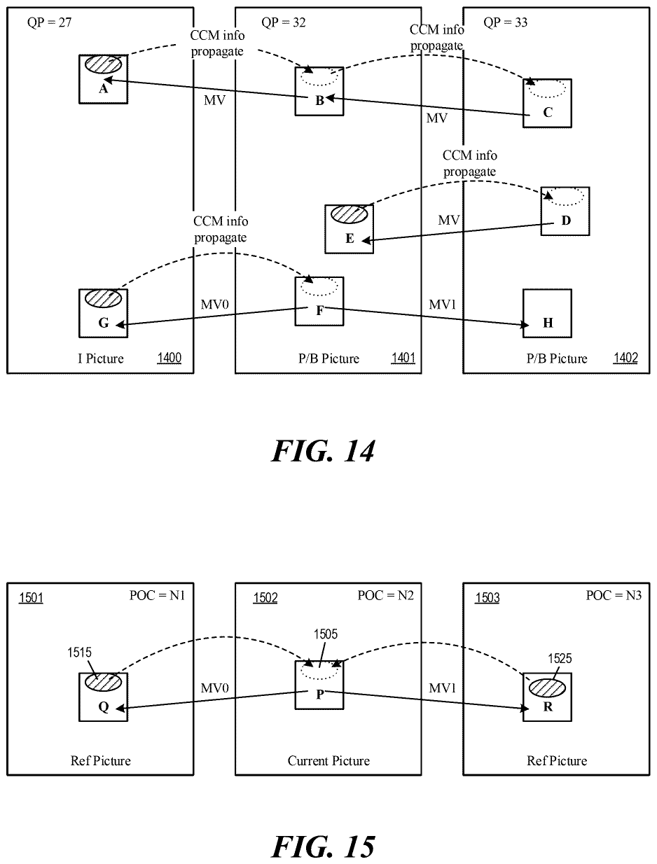

FIG. 14 illustrates examples of CCM information propagation based on motion vectors. The figure illustrates several blocks A through H. The blocks A, E, G are coded by using cross-component model (e.g., CCLM, MMLM, GLM, CCCM). As illustrated, block B is not CCP coded and there are motion vectors available at block B. The reference block A is located by the motion vector. The CCM information of the reference block A, which uses cross-component model, is copied and stored for block B.

In some embodiments, if the reference block located by the motion vector is also not CCP coded, but there is CCM information stored for the reference block, the CCM information of the current block can be derived by copying the CCM information stored for the reference block. In the example of FIG. 14, the block C has motion vector available, and its reference block B, which is not CCP coded, has CCM information stored. The CCM information of block B is copied and stored for block C. The CCM information stored for block B was copied from block A. Hence the CCM information of block A is propagated to block C. In some embodiments, if the reference block located by the motion vector is not CCP coded and does not have CCM information stored, no CCM information is stored for the current block.

In some embodiments, when the current block is inter-coded with bi-directional prediction, to derive the CCM information of the current block, if only one of the reference blocks located by the motion vectors has CCM information, the CCM information from the reference block which has CCM information is copied to and stored for the current block. For example, as shown in FIG. 14, block F is inter-coded with bi-directional prediction, the two reference blocks located by the motion vectors (MV0 and MV1) of block F are block G and block H. Block G has stored CCM information and block H does not. The CCM information of block G is copied to and stored for block F.

In some embodiments, when the current block is inter-coded with bi-directional prediction, and both reference blocks located by the motion vectors have stored CCM information, the video coder determines/derives the CCM information to be stored for the current block based on the CCM information of the more than one reference blocks. FIG. 15 illustrates a current block having two motion vectors identifying two reference blocks and that both have CCM information. As illustrated, a current block (block P) is inter-coded with bi-directional prediction in current picture 1502. The two reference blocks (block Q and block R) are located by motion vectors in different reference pictures 1501 and 1503. The reference block Q is located by block vector MV0 and has CCM information 1515. The reference block R is located by block vector MV1 and has CCM information 1525. Reference blocks Q and R may or may not be coded by CCP. The video coder determines the CCM information 1505 for the current block P based on the CCM information 1515 and the CCM information 1525.

The video coder in different embodiments determines the current block CCM information 1505 differently. For example, in some embodiments, the current block CCM information 1505 is derived by combining of all or a subset of the CCM models 1515 and 1525 of the reference blocks Q and R. For another example, ins some embodiments, one of the reference blocks is selected based on a set of pre-defined rules. The CCM information of the selected reference block is then copied and stored for the current block.

In some embodiments, to select from the one or more reference blocks for obtain the CCM information, the reference block which is CCP coded is selected. In some embodiments, the reference block which is intra coded is selected. In some embodiments, the reference block which is inter- or IBC-coded is selected.

In some embodiments, the reference block whose reference picture (i.e., the picture the reference block is in) has the smaller POC distance to the current picture is selected. The CCM information of the selected reference block is copied to and stored for the current block. In the example of FIG. 15, block P is inter-coded with bi-directional prediction. The two reference blocks Q an R are located by the motion vectors and both have stored CCM information. The reference picture 1501 containing reference block Q has POC=N1, the current picture 1502 has POC=N2, the reference picture 1503 has POC=N3. If |N1−N2| is smaller than |N3−N2|, then block Q is selected, and the CCM information 1515 of block Q is copied to and stored for block P as the current block CCM information 1505.

In some embodiments, the reference block whose reference picture has the smaller/smallest QP difference from the current picture is selected. The CCM information of the selected reference block is copied to and stored for the current block. In the example of FIG. 14, block F in picture 1401 is inter-coded with bi-directional prediction. The two reference blocks located by the motion vectors are block G in picture 1400 and block H in picture 1402. Assume block G and block H both have stored CCM information. Assume the QPs of the pictures 1400, 1401, and 1402 are 27, 32, 33 respectively. Since |33−32| is smaller than |27−32|, block H is selected, and the CCM information of block H is copied to and stored for block F.

In some embodiments, the reference block whose reference picture has the smaller QP value is selected (so in the example of FIG. 14, block G would be selected since picture 1400 has the smaller QP value 27.) In some embodiments, the reference block whose reference picture has the larger QP values is selected (so in the example of FIG. 14, block H would be selected since picture 1402 has the larger QP value 33.)

In some embodiments, the reference block that is indicated by the L0 motion vector is selected. In some embodiments, the reference block that is indicated by the L1 motion vector is selected. In some embodiments, the rules described previously can be combined, and not all the rules described previously need to be applied. For example, the reference block which is CCP coded is selected. If both blocks are CCP coded, then the block whose reference picture has the smaller POC distance to the current picture is selected. If both blocks are CCP coded and has the same POC distance to the current picture, the reference block whose reference picture has the smaller QP difference from the current picture is selected. If both blocks are CCP coded, has the same POC distance to the current picture, and has the same QP difference from the current picture, then the reference block whose reference picture has the smaller QP value is selected. For another example, the block whose reference picture has the smaller POC distance to the current picture is selected. If both blocks have the same POC distance to the current picture, the reference block whose reference picture has the smaller QP difference from the current picture is selected. If both blocks have the same POC distance to the current picture and have the same QP difference from the current picture, then the reference block whose reference picture has the smaller QP value is selected.

In some embodiments, if the current block is inter-coded or there's block vector available in the current block, the CCM information of the current block can be derived by copying the CCM information of the reference block located by the motion vector or the block vector. For example, as shown in the following figure, the current block C has block vector available, and its referenced block B has motion vector available. The CCM information of block B is coped from block A. The CCM information of block B is then copied to block C. Hence the CCM information of block A is propagated to the current block C.

### L. Inheriting Multiple Cross-Component Models

In some embodiments, if the current candidate list size is N, the video coder may select k candidates from the total N candidates (where k≤N). The k cross-component models can be combined into one final cross-component model by weighted-averaging the corresponding model parameters. For example, if a cross-component model has M parameters, the j-th parameter of the final cross-component model is the weighted-averaging of the j-th parameter of the k selected candidates where j is 1 . . . M. Then, the final prediction is generated by applying the final cross-component model to the corresponding luma reconstruction samples. For example, in some embodiments, if two candidate models are

$$\{ {c}_{0}^{0} , {c}_{1}^{0} , … , {c}_{M - 1}^{0} \} and \{ {c}_{0}^{1} , {c}_{1}^{1} , … , {c}_{M - 1}^{1} \} .$$

The final cross-component model is

$$\{ ( 1 - α ) \times {c}_{0}^{0} + α \times {c}_{0}^{1} , ( 1 - α ) \times {c}_{1}^{0} + α \times {c}_{1}^{1} , … , ( 1 - α ) \times {c}_{M - 1}^{0} + α \times {c}_{M - 1}^{1} \} ,$$

where α is a weighting factor which can be predefined or implicitly derived according to neighboring template cost, and

$${c}_{x}^{y}$$

is the x-th model parameter of the y-th candidate.

In some embodiments, by using the template cost defined in Section III.i (Reorder the candidates in the list), the corresponding template cost of the two candidates are e^{cand1} and e^{cand2}, then a is e^{cand1}/(e^{cand1}+e^{cand2}).

In some embodiments, the video coder may combine multiple cross-component models into one final cross-component model. For example, the video coder may choose a first model from a first candidate and a second model from a second candidate to form a multi-model mode (e.g., a MMLM or MM-CCCM). The selected candidate can be CCLM/MMLM/GLM/CCCM coded candidate. The multi-model classification threshold can be the average of the offset parameters (e.g., offset/β in CCLM, or c₆×B or c₆ in CCCM) of the two selected modes. In some embodiments, the classification threshold is set to be the average value of the neighboring luma and chroma samples of the current block.

m. Storing Temporal Models in an Indexed Table

In some embodiments, CCM information from previous coded slices/pictures are stored in a table, and a picture-level index buffer is created to store the index of the table. The index buffer has the same size as the picture. When referencing the CCM information at position (x, y) inside the collocated picture (as described in Section III.d “Inheriting temporal neighboring model parameters”), an index value is retrieved from the position (x, y) in the index buffer of the collocated picture. An item in the table indicated by the index value is obtained as the CCM information to be referenced. If the index value indicates that no CCM information is available at position (x, y), then no CCM information is referenced.

In some embodiments, the table to store CCM information is a picture-level table. CCM information from each picture is stored in a separate table. In some embodiments, one table is created to store CCM information from all pictures. In some embodiments, one table is created for each temporal id. CCM information from the layer with the same temporal id is stored in the same table. In some embodiments, several tables are used to store CCM information from one picture. A picture can be divided into several regions, with each region corresponding to its own table.

In some embodiments, after storing CCM information at position (x, y) of the current encoding/decoding picture into the corresponding table, the table index value of that CCM information is saved in the index buffer of the current encoding/decoding picture at position (x, y). If no CCM information is available at position (x, y) (e.g., when the CU covering position (x, y) is not coded using any of CCLM, MMLM, CCCM, CCCM multi-models, chroma fusion, or other cross-component models.), the value at position (x, y) in the index buffer is set to indicate that no CCM information is available.

In some embodiments, if CCM information is not available at position (x, y) of the current encoding/decoding picture, the index value at position (x, y) in the index buffer of the collocated picture can be stored at position (x, y) in the index buffer of the current encoding/decoding picture.

In some embodiments, if CCM information is not available at position (x, y) of the current encoding/decoding picture, and there is a block vector (Δx, Δy) available at the position (x, y) (e.g., the block at position (x, y) can be IBC coded or IntraTMP coded, or the collocated luma block is coded in IBC or IntraTMP mode), the index value at position (x+Δx, y+Δy) in the index buffer can be stored at position (x, y) in the index buffer of the current encoding/decoding picture. In another embodiment, if CCM information is not available at position (x, y) of the current encoding/decoding picture, and there are multiple block vectors available, (Δxi, Δyi), 0<i≤N, N≥1, at the position (x, y) (e.g., the luma block at the position (x, y) can have bi-directional block vector, or the chroma block at the position (x, y) can have multiple collocated luma blocks which have block vectors), the index value at one of the positions (x+Δxi, y+Δyi) in the index buffer can be stored at position (x, y) in the index buffer of the current encoding/decoding picture. In some embodiments, there can be a set of pre-defined rules to determine how to select one of the block vectors (i.e., select and store the index value and the corresponding cross-component model located by the block vector (Δxi, Δyi)). The rules can be the same as the rules to select one of the reference blocks located by the block vectors described in Section III.k “Vector propagated cross-component models”.

In some embodiments, if CCM information is not available at position (x, y) of the current encoding/decoding picture, and the block at position (x, y) is inter-coded and the motion vector is (Δx, Δy), the index value at position (x+Δx, y+Δy) in the index buffer of the reference picture (also indicated by the motion vector) can be stored at position (x, y) in the index buffer of the current encoding/decoding picture. In some embodiments, if CCM information is not available at position (x, y) of the current encoding/decoding picture, and the block at position (x, y) is inter-coded and the motion vector is bi-directional (Δxi, Δyi), i=0 or 1. The index value at one of the positions (x+Δxi, y+Δyi) in the index buffer of the reference picture (also indicated by the motion vector) can be stored at position (x, y) in the index buffer of the current encoding/decoding picture.

In some embodiments, if CCM information is not available at position (x, y) of the current encoding/decoding picture, and the block at position (x, y) is inter-coded and the motion vector is (Δx, Δy), the index value at position (x+Δx, y+Δy) in the index buffer of the reference picture, which is also indicated by the motion vector, can be used to retrieve CCM information from the table corresponding to the reference picture. The retrieved CCM information is then stored into the table corresponding to the current picture. The table index value of retrieved CCM information is saved in the index buffer of the current encoding/decoding picture at position (x, y).

In some embodiments, if CCM information is not available at position (x, y) of the current encoding/decoding picture, and the block at position (x, y) is inter-coded and the motion vector is bi-directional (Δxi, Δyi), i=0 or 1. The index value at one of the positions (x+Δxi, y+Δyi) in the index buffer of the reference picture, which is also indicated by the motion vector, can be used to retrieve CCM information from the table corresponding to the reference picture. The retrieved CCM information is then stored into the table corresponding to the current picture. The table index value of retrieved CCM information is saved in the index buffer of the current encoding/decoding picture at position (x, y). In some embodiments, there can be a set of pre-defined rules to determine how to select one of the motion vectors (i.e., retrieve the index value located by the motion vector (Δxi, Δyi) and store the corresponding cross-component model in the current table). The rules can be the same as the rules to select one of the reference blocks located by the motion vectors described in Section III.k “Vector propagated cross-component models”.

In some embodiments, when deleting a CCM information from a table, all values in the index buffers that indicate to use the to-be-deleted CCM information are reset to indicate that no CCM information is available. Assume the index value of the to-be-deleted CCM information is N, all values in the index buffer that are greater than N will be decreased by 1.

In some embodiments, there is a maximum size limit for a table used to store CCM information. A high-level syntax can be signaled in SPS, PPS, PH or SH to indicate the maximum size limit. If a table has reached its maximum size when attempting to store new CCM information into the table, the new CCM information is not stored into the table. In some embodiments, if a table has reached its maximum size when attempting to store new CCM information into the table, the CCM information stored earliest is deleted to free up space in the table.

In some embodiments, the table can be reset at the beginning of encoding/decoding of an IDR picture. In some embodiments, the table can be reset after encoding/decoding of an IDR picture. In some embodiments, the table can be reset at the beginning of encoding/decoding of a CRA picture. In some embodiments, the table can be reset after encoding/decoding of a CRA picture. In some embodiments, the reset mechanism can be the same as that used in parameter set or reference pictures.

In some embodiments, indexes stored in the index buffer can only be referenced by a unit larger than or equal to the smallest coding unit. For example, if the smallest coding unit is 4×4, the indexes can be reference by an 8×8 grid. That is, one 8×8 block has the same index value. To retrieve index value at position (x, y), the position (x, y) can be rounded to a point on the grid (e.g., (x>>3)<<3, (y>>3)<<3) or to its nearest point on the grid.

In some embodiments, the CCM information to be stored in the table can be explicitly signaled in the bitstream in SPS, PPS, PH or SH. The corresponding positions of the CCM information can also be signaled.

Any of the foregoing proposed methods can be implemented in encoders and/or decoders. For example, any of the proposed methods can be implemented in an inter/intra/prediction module of an encoder, and/or an inter/intra/prediction module of a decoder. Alternatively, any of the proposed methods can be implemented as a circuit coupled to the inter/intra/prediction module of the encoder and/or the inter/intra/prediction module of the decoder, so as to provide the information needed by the inter/intra/prediction module

### IV. Example Video Encoder

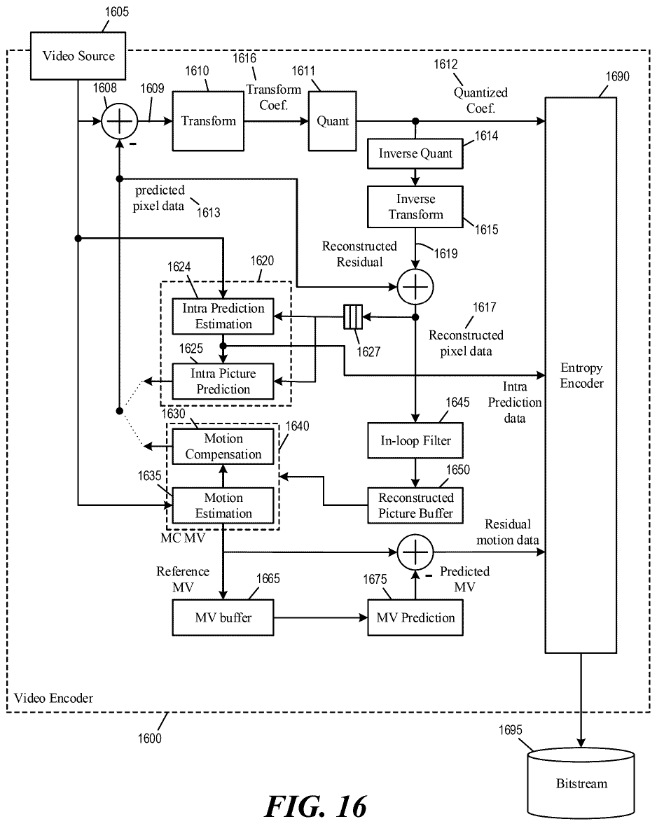

FIG. 16 illustrates an example video encoder 1600 that may implement cross-component prediction. As illustrated, the video encoder 1600 receives input video signal from a video source 1605 and encodes the signal into bitstream 1695. The video encoder 1600 has several components or modules for encoding the signal from the video source 1605, at least including some components selected from a transform module 1610, a quantization module 1611, an inverse quantization module 1614, an inverse transform module 1615, an intra-picture estimation module 1624, an intra-prediction module 1625, a motion compensation module 1630, a motion estimation module 1635, an in-loop filter 1645, a reconstructed picture buffer 1650, a MV buffer 1665, and a MV prediction module 1675, and an entropy encoder 1690. The motion compensation module 1630 and the motion estimation module 1635 are part of an inter-prediction module 1640. The intra-prediction module 1625 and the intra-prediction estimation module 1624 are part of a current picture prediction module 1620, which uses current picture reconstructed samples as reference samples for prediction of the current block.

In some embodiments, the modules 1610-1690 are modules of software instructions being executed by one or more processing units (e.g., a processor) of a computing device or electronic apparatus. In some embodiments, the modules 1610-1690 are modules of hardware circuits implemented by one or more integrated circuits (ICs) of an electronic apparatus. Though the modules 1610-1690 are illustrated as being separate modules, some of the modules can be combined into a single module.

The video source 1605 provides a raw video signal that presents pixel data of each video frame without compression. A subtractor 1608 computes the difference between the raw video pixel data of the video source 1605 and the predicted pixel data 1613 from the motion compensation module 1630 or intra-prediction module 1625 as prediction residual 1609. The transform module 1610 converts the difference (or the residual pixel data or residual signal 1608) into transform coefficients (e.g., by performing Discrete Cosine Transform, or DCT). The quantization module 1611 quantizes the transform coefficients into quantized data (or quantized coefficients) 1612, which is encoded into the bitstream 1695 by the entropy encoder 1690.

The inverse quantization module 1614 de-quantizes the quantized data (or quantized coefficients) 1612 to obtain transform coefficients, and the inverse transform module 1615 performs inverse transform on the transform coefficients to produce reconstructed residual 1619. The reconstructed residual 1619 is added with the predicted pixel data 1613 to produce reconstructed pixel data 1617. In some embodiments, the reconstructed pixel data 1617 is temporarily stored in a line buffer 1627 (or intra prediction buffer) for intra-picture prediction and spatial MV prediction. The reconstructed pixels are filtered by the in-loop filter 1645 and stored in the reconstructed picture buffer 1650. In some embodiments, the reconstructed picture buffer 1650 is a storage external to the video encoder 1600. In some embodiments, the reconstructed picture buffer 1650 is a storage internal to the video encoder 1600.

The intra-picture estimation module 1624 performs intra-prediction based on the reconstructed pixel data 1617 to produce intra prediction data. The intra-prediction data is provided to the entropy encoder 1690 to be encoded into bitstream 1695. The intra-prediction data is also used by the intra-prediction module 1625 to produce the predicted pixel data 1613.

The motion estimation module 1635 performs inter-prediction by producing MVs to reference pixel data of previously decoded frames stored in the reconstructed picture buffer 1650. These MVs are provided to the motion compensation module 1630 to produce predicted pixel data.

Instead of encoding the complete actual MVs in the bitstream, the video encoder 1600 uses MV prediction to generate predicted MVs, and the difference between the MVs used for motion compensation and the predicted MVs is encoded as residual motion data and stored in the bitstream 1695.

The MV prediction module 1675 generates the predicted MVs based on reference MVs that were generated for encoding previously video frames, i.e., the motion compensation MVs that were used to perform motion compensation. The MV prediction module 1675 retrieves reference MVs from previous video frames from the MV buffer 1665. The video encoder 1600 stores the MVs generated for the current video frame in the MV buffer 1665 as reference MVs for generating predicted MVs.

The MV prediction module 1675 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 1695 by the entropy encoder 1690.

The entropy encoder 1690 encodes various parameters and data into the bitstream 1695 by using entropy-coding techniques such as context-adaptive binary arithmetic coding (CABAC) or Huffman encoding. The entropy encoder 1690 encodes various header elements, flags, along with the quantized transform coefficients 1612, and the residual motion data as syntax elements into the bitstream 1695. The bitstream 1695 is in turn stored in a storage device or transmitted to a decoder over a communications medium such as a network.

The in-loop filter 1645 performs filtering or smoothing operations on the reconstructed pixel data 1617 to reduce the artifacts of coding, particularly at boundaries of pixel blocks. In some embodiments, the filtering or smoothing operations performed by the in-loop filter 1645 include deblock filter (DBF), sample adaptive offset (SAO), and/or adaptive loop filter (ALF). In some embodiments, luma mapping chroma scaling (LMCS) is performed before the loop filters.

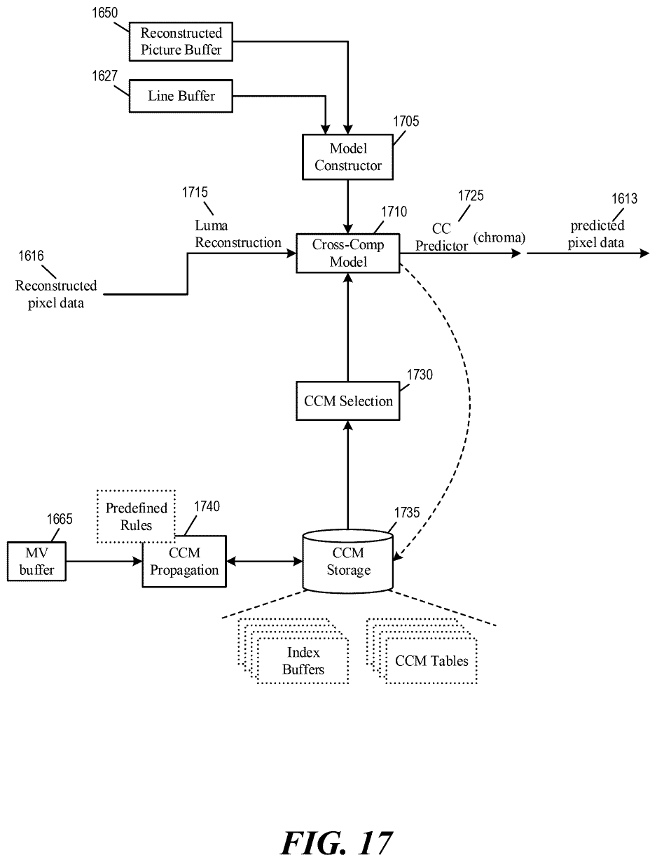

FIG. 17 illustrates portions of the video encoder 1600 that implement propagation of CCM information from multiple reference blocks. Current picture prediction (intra prediction, IBC, and other prediction by referencing the current picture) may be used to generate a reconstruction 1715 for the luma component. A cross-component model 1710 may be applied to the reconstruction 1715 to generate a cross-component predictor 1725 for the chroma component. The cross-component predictor 1725 is then included in the predicted pixel data 1613. The cross-component model 1710 may also be stored in a CCM storage 1735 for use by subsequent coded blocks.

The cross-component model 1710 may be generated by a model constructor 1705 based on reference samples and/or current samples (in and/or around the current block and/or a reference block) retrieved from the reconstructed picture buffer 1650 and/or the line buffer 1627. Section I above describe several types of cross-component models that may be used as the cross-component model 1710.

The cross-component model 1710 may also be provided by a CCM selection module 1730, which provide a cross-component model (CCM) information or other cross-component prediction (CCP) information that are inherited from previously coded blocks. In some embodiments, the CCM selection module 1730 may provide a CCP merge candidate list, which may include models from spatial, temporal, and non-adjacent neighbors, and/or from history tables and/or from default candidates. The CCM selection module 1730 may provide CCM information of the selected candidate to the current block. The propagated CCM information may serve as the cross-component model 1710 for the current block, or to be saved in the CCM storage 1735 to be propagated further.

A CCM propagation module 1740 may propagate CCM information from a reference block's multiple reference blocks to the reference block by updating the content of the CCM storage 1735. The reference block's reference blocks may be identified by the motion vectors and/or block vectors of the reference block. When multiple further reference blocks located by multiple MVs or BVs all/both have CCM information, the CCM propagation module 1740 may combine the CCM information from the multiple further reference blocks. The CCM propagation module 1740 may also select one of the further multiple reference blocks from which to obtain the CCM information. In some embodiments, a set of predefined rules may be applied to select one further reference block from the multiple further reference blocks. Examples of such rules include: select the further reference block that is spatially or temporally closest to the reference block; select the further reference block with quantization parameter (of the reference picture) that is most similar to that of the reference block/reference picture; select the further reference block with the largest or smallest quantization parameter; select the further reference block that is intra coded, or inter coded, or IBC coded; select the further reference block that is located by L0 motion or L1 motion, etc.

The CCM storage 1735 represents (or is implemented by) any form of storage that is used to store CCM information which includes cross-component models generated by the model constructor 1705. The CCM storage 1735 may be portions of the block level buffers, portions of the picture-level, or CCM tables (or indexed tables) for different pictures, different temporal IDs or different regions of different pictures. A CCM table may be associated with a video picture and stores CCM information or other CCP information of the associated picture. A CCM table may also be associated with a temporal ID and stores CCM information or other CCP information of pictures having the associated temporal ID. A CCM table may be associated with a region in a video picture and stores CCM information or other CCP information of the associated region. The stored CCM information and/or CCP information are made available to be inherited by subsequent blocks as merge mode candidates.

Each CCM table has a corresponding index buffer for mapping a position in a picture to a location in the CCM table. To retrieve CCM information and/or CCP information for a selected reference block (or selected candidate), the encoder identifies the CCM table and the corresponding index buffer for the selected reference block (based on picture, temporal ID or region in a picture), then uses the candidate's position in the picture to look up an index in the identified index buffer. The index is in turn used to access the selected CCM information and/or CCP information in the CCM table.

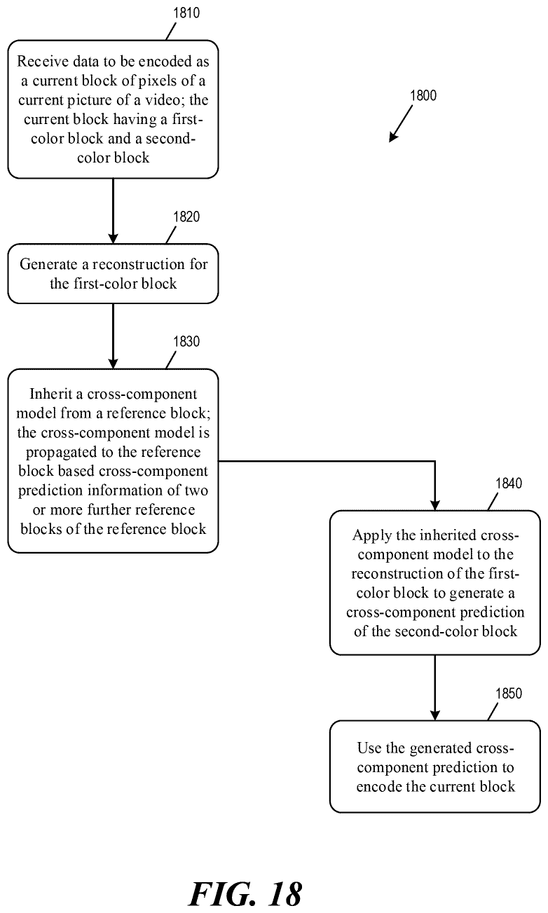

FIG. 18 conceptually illustrates a process 1800 that select from multiple reference blocks having CCM information when encoding block. In some embodiments, one or more processing units (e.g., a processor) of a computing device implementing the encoder 1600 performs the process 1800 by executing instructions stored in a computer readable medium. In some embodiments, an electronic apparatus implementing the encoder 1600 performs the process 1800.

The encoder receives (at block 1810) data to be encoded as a current block of pixels of a current picture of a video. The current block having a first-color block (e.g., luma component block) and a second-color block (e.g., a chroma component block). The encoder generates (at block 1820) a reconstruction for the first-color block.

The encoder inherits (at block 1830) a cross-component model from a reference block; the cross-component model is propagated to the reference block based on cross-component information of two or more further reference blocks of the reference block.

The more than one further reference blocks may be located by more than one motion vectors or block vectors of the reference block (such as when the reference block is a bidirectional inter-predicted block.) In some embodiments, the encoder derives the cross-component model by combining all or a subset of the CCM models of the more than one further reference blocks.

In some embodiments, the encoder propagates the cross-component model by selecting one block from the more than one further reference blocks of the reference block to provide the cross-component model for the reference block. The one further reference block may be selected according to a set of predefined rules. The reference block may or may not be coded by cross-component prediction. The encoder may select the one further reference block by identifying a block that is coded by cross-component prediction. The encoder may select the only further reference block of the two or more further reference blocks that has a cross-component model. The encoder may select the one further reference block by identifying a block that is coded by current picture referencing (e.g., IBC mode), or by identifying a block that is coded by intra prediction, or by identifying a block that is coded by inter prediction.

In some embodiments, the one further reference block is selected by identifying a block having a shortest spatial distance from the reference block among the one or more further reference blocks. The spatial distance may be vertical or horizontal distance, or Euclidean distance, or Manhattan distance, or Minkowski distance. In some embodiments, the one further reference block is selected by identifying a block among the one or more further reference blocks having a shortest temporal distance from the reference block. The temporal distance of a block may be determined based on the POC of the further reference picture containing the block and the POC of the reference picture.

The one further reference block may be selected by identifying a block among the one or more further reference blocks having a QP that is closest to the quantization parameter of the reference block, or by identifying a block having a largest QP among the one or more further reference blocks, or by identifying a block having a smallest QP among the one or more further reference blocks, or identifying a block that is indicated by a L0 (or L1) motion vector among the one or more further reference blocks.

The encoder applies (at block 1840) the inherited cross-component model to the reconstruction of the first-color block to generate a cross-component prediction of the second-color block. The encoder may use (at block 1850) the generated cross-component prediction to encode the current block (by generating prediction residual), or store (at block 1860) the determined cross-component model for coding a subsequent block.

### V. Example Video Decoder

In some embodiments, an encoder may signal (or generate) one or more syntax element in a bitstream, such that a decoder may parse said one or more syntax element from the bitstream.

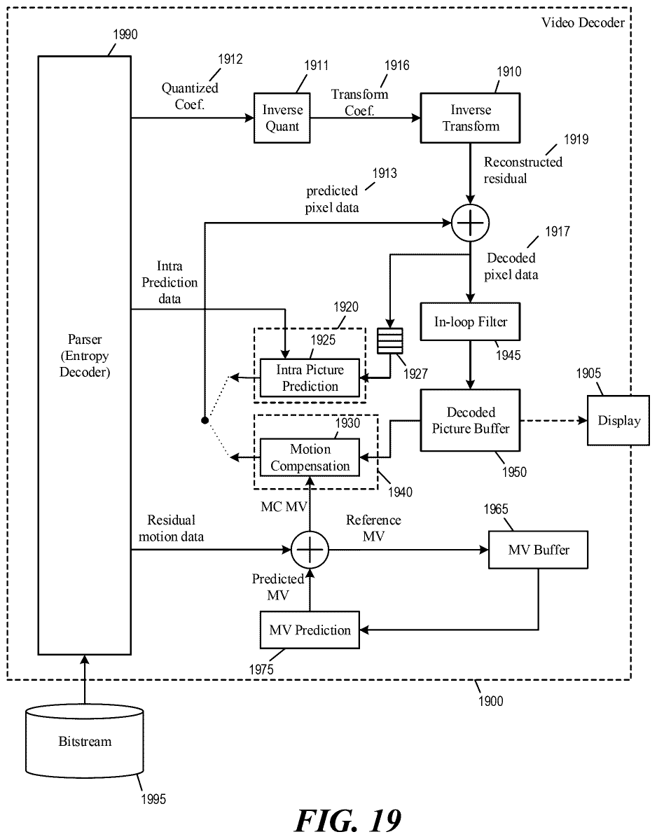

FIG. 19 illustrates an example video decoder 1900 that may implement cross-component prediction. As illustrated, the video decoder 1900 is an image-decoding or video-decoding circuit that receives a bitstream 1995 and decodes the content of the bitstream into pixel data of video frames for display. The video decoder 1900 has several components or modules for decoding the bitstream 1995, including some components selected from an inverse quantization module 1911, an inverse transform module 1910, an intra-prediction module 1925, a motion compensation module 1930, an in-loop filter 1945, a decoded picture buffer 1950, a MV buffer 1965, a MV prediction module 1975, and a parser 1990. The motion compensation module 1930 is part of an inter-prediction module 1940. The intra-prediction module 1925 is part of a current picture prediction module 1920, which uses current picture reconstructed samples as reference samples for prediction of the current block.

In some embodiments, the modules 1910-1990 are modules of software instructions being executed by one or more processing units (e.g., a processor) of a computing device. In some embodiments, the modules 1910-1990 are modules of hardware circuits implemented by one or more ICs of an electronic apparatus. Though the modules 1910-1990 are illustrated as being separate modules, some of the modules can be combined into a single module.

The parser 1990 (or entropy decoder) receives the bitstream 1995 and performs initial parsing according to the syntax defined by a video-coding or image-coding standard. The parsed syntax element includes various header elements, flags, as well as quantized data (or quantized coefficients) 1912. The parser 1990 parses out the various syntax elements by using entropy-coding techniques such as context-adaptive binary arithmetic coding (CABAC) or Huffman encoding.

The inverse quantization module 1911 de-quantizes the quantized data (or quantized coefficients) 1912 to obtain transform coefficients, and the inverse transform module 1910 performs inverse transform on the transform coefficients 1916 to produce reconstructed residual signal 1919. The reconstructed residual signal 1919 is added with predicted pixel data 1913 from the intra-prediction module 1925 or the motion compensation module 1930 to produce decoded pixel data 1917. The decoded pixels data are filtered by the in-loop filter 1945 and stored in the decoded picture buffer 1950. In some embodiments, the decoded picture buffer 1950 is a storage external to the video decoder 1900. In some embodiments, the decoded picture buffer 1950 is a storage internal to the video decoder 1900.

The intra-prediction module 1925 receives intra-prediction data from bitstream 1995 and according to which, produces the predicted pixel data 1913 from the decoded pixel data 1917 stored in the decoded picture buffer 1950. In some embodiments, the decoded pixel data 1917 is also stored in a line buffer 1927 (or intra prediction buffer) for intra-picture prediction and spatial MV prediction.

In some embodiments, the content of the decoded picture buffer 1950 is used for display. A display device 1905 either retrieves the content of the decoded picture buffer 1950 for display directly, or retrieves the content of the decoded picture buffer to a display buffer. In some embodiments, the display device receives pixel values from the decoded picture buffer 1950 through a pixel transport.

The motion compensation module 1930 produces predicted pixel data 1913 from the decoded pixel data 1917 stored in the decoded picture buffer 1950 according to motion compensation MVs (MC MVs). These motion compensation MVs are decoded by adding the residual motion data received from the bitstream 1995 with predicted MVs received from the MV prediction module 1975.

The MV prediction module 1975 generates the predicted MVs based on reference MVs that were generated for decoding previous video frames, e.g., the motion compensation MVs that were used to perform motion compensation. The MV prediction module 1975 retrieves the reference MVs of previous video frames from the MV buffer 1965. The video decoder 1900 stores the motion compensation MVs generated for decoding the current video frame in the MV buffer 1965 as reference MVs for producing predicted MVs.

The in-loop filter 1945 performs filtering or smoothing operations on the decoded pixel data 1917 to reduce the artifacts of coding, particularly at boundaries of pixel blocks. In some embodiments, the filtering or smoothing operations performed by the in-loop filter 1945 include deblock filter (DBF), sample adaptive offset (SAO), and/or adaptive loop filter (ALF). In some embodiments, luma mapping chroma scaling (LMCS) is performed before the loop filters.

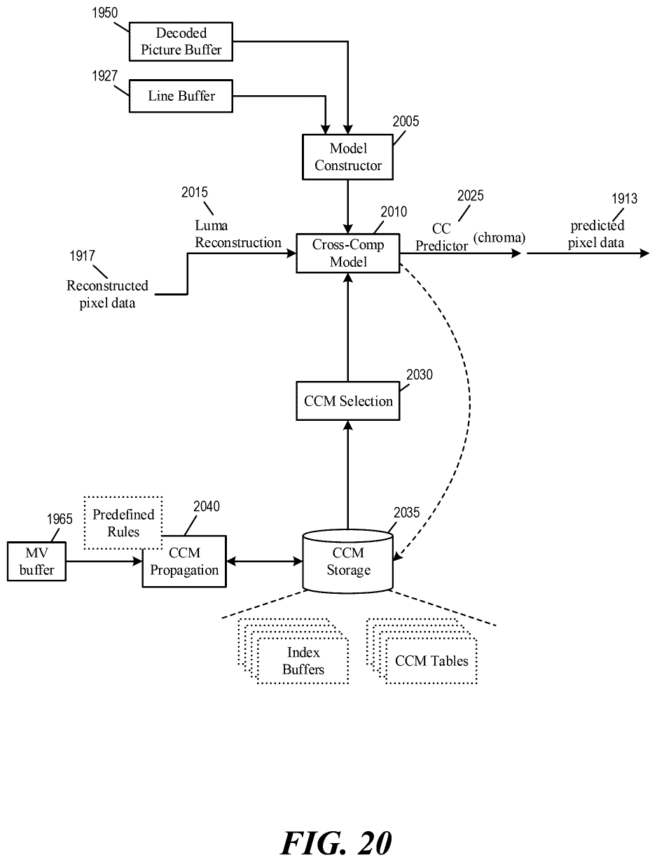

FIG. 20 illustrates portions of the video decoder 1900 that implement propagation of CCM information from multiple reference blocks. Current picture prediction (intra prediction, IBC, and other prediction by referencing the current picture) may be used to generate a reconstruction 2015 for the luma component. A cross-component model 2010 may be applied to the reconstruction 2015 to generate a cross-component predictor 2025 for the chroma component. The cross-component predictor 2025 is then included in the predicted pixel data 1913. The cross-component model 2010 may also be stored in a CCM storage 2035 for use by subsequent coded blocks.

The cross-component model 2010 may be generated by a model constructor 2005 based on reference samples and/or current samples (in and/or around the current block and/or a reference block) retrieved from the reconstructed picture buffer 1950 and/or the line buffer 1927. Section I above describe several types of cross-component models that may be used as the cross-component model 2010.

The cross-component model 2010 may also be provided by a CCM selection module 2030, which provide a cross-component model (CCM) information or other cross-component prediction (CCP) information that are inherited from previously coded blocks. In some embodiments, the CCM selection module 2030 may provide a CCP merge candidate list, which may include models from spatial, temporal, and non-adjacent neighbors, and/or from history tables and/or from default candidates. The CCM selection module 2030 may provide CCM information of the selected candidate to the current block. The propagated CCM information may serve as the cross-component model 2010 for the current block, or to be saved in the CCM storage 2035 to be propagated further.

A CCM propagation module 2040 may propagate CCM information from a reference block's multiple reference blocks to the reference block by updating the content of the CCM storage 2035. The reference block's reference blocks may be identified by the motion vectors and/or block vectors of the reference block. When multiple further reference blocks located by multiple MVs or BVs all/both have CCM information, the CCM propagation module 2040 may combine the CCM information from the multiple further reference blocks. The CCM propagation module 2040 may also select one of the further multiple reference blocks from which to obtain the CCM information. In some embodiments, a set of predefined rules may be applied to select one further reference block from the multiple further reference blocks. Examples of such rules include: select the further reference block that is spatially or temporally closest to the reference block; select the further reference block with quantization parameter (of the reference picture) that is most similar to that of the reference block/reference picture; select the further reference block with the largest or smallest quantization parameter; select the further reference block that is intra coded, or inter coded, or IBC coded; select the further reference block that is located by L0 motion or L1 motion, etc.

The CCM storage 2035 represents (or is implemented by) any form of storage that is used to store CCM information which includes cross-component models generated by the model constructor 2005. The CCM storage 2035 may be portions of the block level buffers, portions of the picture-level, or CCM tables (or indexed tables) for different pictures, different temporal IDs or different regions of different pictures. A CCM table may be associated with a video picture and stores CCM information or other CCP information of the associated picture. A CCM table may also be associated with a temporal ID and stores CCM information or other CCP information of pictures having the associated temporal ID. A CCM table may be associated with a region in a video picture and stores CCM information or other CCP information of the associated region. The stored CCM information and/or CCP information are made available to be inherited by subsequent blocks as merge mode candidates.

Each CCM table has a corresponding index buffer for mapping a position in a picture to a location in the CCM table. To retrieve CCM information and/or CCP information for a selected reference block (or selected candidate), the decoder identifies the CCM table and the corresponding index buffer for the selected reference block (based on picture, temporal ID or region in a picture), then uses the candidate's position in the picture to look up an index in the identified index buffer. The index is in turn used to access the selected CCM information and/or CCP information in the CCM table.

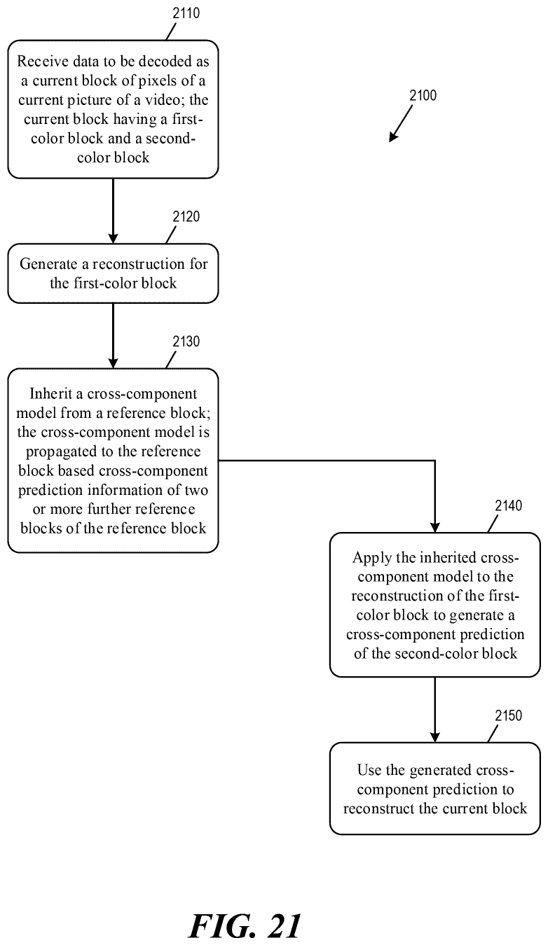

FIG. 21 conceptually illustrates a process 2100 for propagating CCM information from multiple reference blocks when decoding a block. In some embodiments, one or more processing units (e.g., a processor) of a computing device implementing the decoder 1900 performs the process 2100 by executing instructions stored in a computer readable medium. In some embodiments, an electronic apparatus implementing the decoder 1900 performs the process 2100.

The decoder receives (at block 2110) data to be decoded as a current block of pixels of a current picture of a video. The current block having a first-color block (e.g., luma component block) and a second-color block (e.g., a chroma component block). The decoder generates (at block 2120) a reconstruction for the first-color block.

The decoder inherits (at block 2130) a cross-component model from a reference block; the cross-component model is propagated to the reference block based on cross-component information of two or more further reference blocks of the reference block.

The more than one further reference blocks may be located by more than one motion vectors or block vectors of the reference block (such as when the reference block is a bidirectional inter-predicted block.) In some embodiments, the decoder derives the cross-component model by combining all or a subset of the CCM models of the more than one further reference blocks.

In some embodiments, the decoder propagates the cross-component model by selecting one block from the more than one further reference blocks of the reference block to provide the cross-component model for the reference block. The one further reference block may be selected according to a set of predefined rules. The reference block may or may not be coded by cross-component prediction. The decoder may select the one further reference block by identifying a block that is coded by cross-component prediction. The decoder may select the only further reference block of the two or more further reference blocks that has a cross-component model. The decoder may select the one further reference block by identifying a block that is coded by current picture referencing (e.g., IBC mode), or by identifying a block that is coded by intra prediction, or by identifying a block that is coded by inter prediction.

In some embodiments, the one further reference block is selected by identifying a block having a shortest spatial distance from the reference block among the one or more further reference blocks. The spatial distance may be vertical or horizontal distance, or Euclidean distance, or Manhattan distance, or Minkowski distance. In some embodiments, the one further reference block is selected by identifying a block among the one or more further reference blocks having a shortest temporal distance from the reference block. The temporal distance of a block may be determined based on the POC of the further reference picture containing the block and the POC of the reference picture.

The one further reference block may be selected by identifying a block among the one or more further reference blocks having a QP that is closest to the quantization parameter of the reference block, or by identifying a block having a largest QP among the one or more further reference blocks, or by identifying a block having a smallest QP among the one or more further reference blocks, or identifying a block that is indicated by a L0 (or L1) motion vector among the one or more further reference blocks.

The decoder applies (at block 2140) the inherited cross-component model to the reconstruction of the first-color block to generate a cross-component prediction of the second-color block. The decoder may use (at block 2150) the generated cross-component prediction to reconstruct the current block (by e.g., combining with prediction residual) or store (at block 2160) the determined cross-component model for coding a subsequent block. The decoder may then provide the reconstructed current block for display as part of the reconstructed current picture.

### VI. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

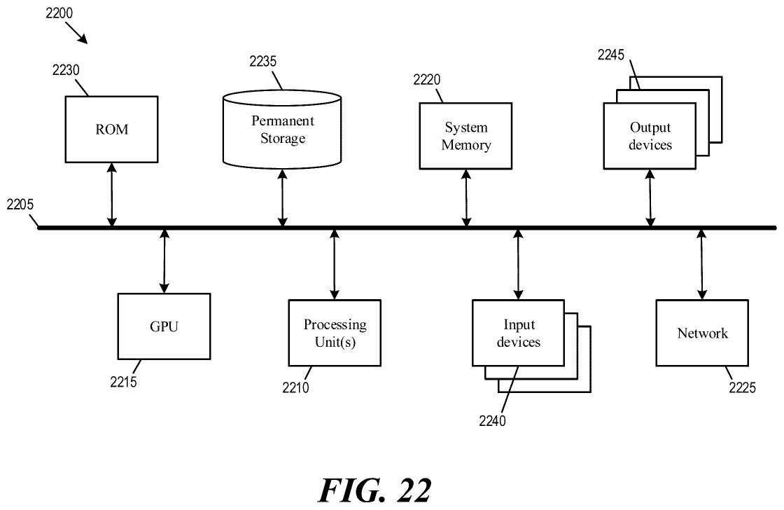

FIG. 22 conceptually illustrates an electronic system 2200 with which some embodiments of the present disclosure are implemented. The electronic system 2200 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 2200 includes a bus 2205, processing unit(s) 2210, a graphics-processing unit (GPU) 2215, a system memory 2220, a network 2225, a read-only memory 2230, a permanent storage device 2235, input devices 2240, and output devices 2245.

The bus 2205 collectively represents all system, peripheral, and chipset buses that communicatively connect the numerous internal devices of the electronic system 2200. For instance, the bus 2205 communicatively connects the processing unit(s) 2210 with the GPU 2215, the read-only memory 2230, the system memory 2220, and the permanent storage device 2235.

From these various memory units, the processing unit(s) 2210 retrieves instructions to execute and data to process in order to execute the processes of the present disclosure. The processing unit(s) may be a single processor or a multi-core processor in different embodiments. Some instructions are passed to and executed by the GPU 2215. The GPU 2215 can offload various computations or complement the image processing provided by the processing unit(s) 2210.

The read-only-memory (ROM) 2230 stores static data and instructions that are used by the processing unit(s) 2210 and other modules of the electronic system. The permanent storage device 2235, on the other hand, is a read-and-write memory device. This device is a non-volatile memory unit that stores instructions and data even when the electronic system 2200 is off. Some embodiments of the present disclosure use a mass-storage device (such as a magnetic or optical disk and its corresponding disk drive) as the permanent storage device 2235.

Other embodiments use a removable storage device (such as a floppy disk, flash memory device, etc., and its corresponding disk drive) as the permanent storage device. Like the permanent storage device 2235, the system memory 2220 is a read-and-write memory device. However, unlike storage device 2235, the system memory 2220 is a volatile read-and-write memory, such a random access memory. The system memory 2220 stores some of the instructions and data that the processor uses at runtime. In some embodiments, processes in accordance with the present disclosure are stored in the system memory 2220, the permanent storage device 2235, and/or the read-only memory 2230. For example, the various memory units include instructions for processing multimedia clips in accordance with some embodiments. From these various memory units, the processing unit(s) 2210 retrieves instructions to execute and data to process in order to execute the processes of some embodiments.

The bus 2205 also connects to the input and output devices 2240 and 2245. The input devices 2240 enable the user to communicate information and select commands to the electronic system. The input devices 2240 include alphanumeric keyboards and pointing devices (also called “cursor control devices”), cameras (e.g., webcams), microphones or similar devices for receiving voice commands, etc. The output devices 2245 display images generated by the electronic system or otherwise output data. The output devices 2245 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 22, bus 2205 also couples electronic system 2200 to a network 2225 through a network adapter (not shown). In this manner, the computer can be a part of a network of computers (such as a local area network (“LAN”), a wide area network (“WAN”), or an Intranet, or a network of networks, such as the Internet. Any or all components of electronic system 2200 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 18 and FIG. 21) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data to be encoded or decoded as a current block of pixels of a current picture of a video, wherein the current block comprises a first-color block and a second-color block;
generating a reconstruction for the first-color block;
inheriting a cross-component model from a reference block, where the cross-component model is propagated to the reference block based on cross-component models of two or more further reference blocks of the reference block;
applying the inherited cross-component model to the reconstruction of the first-color block to generate a cross-component prediction of the second-color block; and
using the generated cross-component prediction to encode or decode the current block.

2. The video coding method of claim 1, wherein the two or more further reference blocks are located by more than one motion vectors or block vectors of the reference block.

3. The video coding method of claim 1, wherein the reference block is not coded by cross-component prediction.

4. The video coding method of claim 1, wherein propagating the cross-component model comprises selecting one block from the more than one further reference blocks of the reference block to provide the cross-component model for the reference block.

5. The video coding method of claim 4, wherein the one further reference block of the reference block is selected according to a set of predefined rules.

6. The video coding method of claim 4, wherein selecting the one further reference block of the reference block comprises identifying a block that is coded by cross-component prediction.

7. The video coding method of claim 4, wherein the selected further reference block is the only further reference block of the two or more further reference blocks that has a cross-component model.

8. The video coding method of claim 4, wherein selecting the one further reference block comprises identifying a block that is coded by current picture referencing.

9. The video coding method of claim 4, wherein selecting the one further reference block comprises identifying a block that is coded by intra prediction.

10. The video coding method of claim 4, wherein selecting the one further reference block comprises identifying a block that is coded by inter prediction.

11. The video coding method of claim 4, wherein the one further reference block is selected by identifying a block having a shortest spatial distance from the reference block among the one or more further reference blocks.

12. The video coding method of claim 11, wherein the spatial distance is horizontal distance or vertical distance.

13. The video coding method of claim 4, wherein the one further reference block is selected by identifying a block among the one or more further reference blocks having a shortest temporal distance from the reference block, wherein a temporal distance of a block is determined based on the picture order count (POC) of the further reference picture containing the block and the POC of the reference picture.

14. The video coding method of claim 4, wherein the one further reference block is selected by identifying a block among the one or more further reference blocks having a quantization parameter (QP) that is closest to the quantization parameter of the reference block.

15. The video coding method of claim 4, wherein the one further reference block is selected by identifying a block having a largest quantization parameter (QP) among the one or more further reference blocks.

16. The video coding method of claim 4, wherein the one further reference block is selected by identifying a block having a smallest quantization parameter (QP) among the one or more further reference blocks.

17. The video coding method of claim 4, wherein the one further reference block is selected by identifying a block that is indicated by L0 or L1 motion vector.

18. An electronic apparatus comprising:
a video coder circuit configured to perform operations comprising:
receiving data to be encoded or decoded as a current block of pixels of a current picture of a video, wherein the current block comprises a first-color block and a second-color block;
generating a reconstruction for the first-color block;
inheriting a cross-component model from a reference block, where the cross-component model is propagated to the reference block based on cross-component models of two or more further reference blocks of the reference block;
applying the inherited cross-component model to the reconstruction of the first-color block to generate a cross-component prediction of the second-color block; and
using the generated cross-component prediction to encode or decode the current block.

19. A video decoding method comprising:
receiving data to be decoded as a current block of pixels of a current picture of a video, wherein the current block comprises a first-color block and a second-color block;
generating a reconstruction for the first-color block;
inheriting a cross-component model from a reference block, where the cross-component model is propagated to the reference block based on cross-component models of two or more further reference blocks of the reference block;
applying the inherited cross-component model to the reconstruction of the first-color block to generate a cross-component prediction of the second-color block; and
using the generated cross-component prediction to reconstruct the current block.
